(19) United States
(12) Patent Application Publication
(10) Pub. No.: US 2023/0259923 A1
(43) Pub. Date: Aug. 17, 2023

(54) APPARATUS AND METHODS TO INSTANTIATE AND TRANSACT NFTS USING ATOMIC INSTRUCTIONS WITHOUT SMART CONTRACTS

(71) Applicant: Geeq Corporation, Waterloo (CA)

(72) Inventors: John P. CONLEY, Brentwood, TN (US); Stephanie A. So, Brentwood, TN (US); Lun-Shin YUEN, Palo Alto, CA (US)

(21) Appl. No.: 18/131,642

(22) Filed: Apr. 6, 2023

Related U.S. Application Data
(63) Continuation of application No. PCT/US2021/054139, filed on Oct. 8, 2021.
Application No. PCT/US2021/054139 is a continuation of application No. PCT/US2021/032500, filed on May 14, 2021.
Application No. PCT/US2021/032500 is a continuation of application No. 17/066,375, filed on Oct. 8, 2020.

(51) Int. Cl. G06Q 20/38; H04L 9/08; G06Q 20/36; H04L 9/32

(52) U.S. Cl. CPC G06Q 20/3823; H04L 9/085; G06Q 20/3674; H04L 9/3213; G06Q 2220/00; H04L 2209/56; H04L 9/50

(57) ABSTRACT

Methods, apparatus and techniques are disclosed to atomically instantiate a secure hash locked account record in association with an NFT record (a crypto-asset record) where the account record is stored in a validation layer of a blockchain and the NFT record is stored in an application layer. The secure hash locked protocol prevents a transfer of the NFT record except with a transfer of the account. The secure hash locked protocol uses first and second hashes of first and second pre-images (e.g. hash locks) to lock the account from transfer. Secure hash locked accounts may be transferred for one another using an unlock, setup and atomic swap transaction process to ensure secure transfer. Once minted, the NFT record is static and is configured to store arbitrary data useful to an external application. As an example, NFT assets may comprise digital assets such as in-game features from video games.

### CROSS-REFERENCE

This application is a continuation of PCT International Application No. PCT/US2021/054139, filed Oct. 8, 2021 and entitled, “Apparatus and Methods to Instantiate and Transact NFTs using Atomic Instructions without Smart Contracts” (the “'139 application”), the entire contents of which are incorporated herein by reference. The '139 application claims priority to U.S. application Ser. No. 17/066,375, filed Oct. 8, 2020 and entitled “Apparatus and Methods to Define and Use Bearer Tokens, Certified Tokens and Applications Using Bearer Tokens and Certified Tokens”, the entire contents of which are incorporated herein by reference. The '139 application further claims priority to PCT International Application No. PCT/US2021/032500 filed 14 May 2021, entitled “Apparatus and Methods to Define and Use Bearer Tokens and Certified Tokens and Applications Using Bearer Tokens and Certified Tokens”, the entire contents of which are incorporated herein by reference.

### FIELD

The present disclosure relates to computer networks, crypto-based assets and distributed ledgers, namely blockchains and more particularly to apparatus and methods to instantiate and transact NFTs using atomic instructions and without smart contracts.

### BACKGROUND

Crypto-assets such as coins exist in records maintained in a distributed ledger based on a consensus mechanism performed by nodes of a computer network. Other crypto-assets comprise non-fungible assets that are typically digitized to define non-fungible tokens (NFTs). NFTs are an instance of data stored on the ledger and are associated to a particular digital or physical asset. While coins are mutually interchangeable and thus are fungible, NFTs are not mutually interchangeable and thus are non-fungible.

Distributed ledgers may be public or private and are typically defined as a blockchain. An example of such a public ledger and mechanism is the Bitcoin blockchain (the status of Bitcoin a trademark for financial services is unclear). Other examples of blockchains include the Ethereum™ blockchain (a trademark of Stiftung Ethereum (Ethereum Foundation)) and a Geeq™-based blockchain such as a GeeqChain (Geeq and GeeqChain are a trademarks of Geeq Corporation).

Traditional processes to instantiate and transact NFTs via a cryptographic transaction may be intensive and burdensome, often involving smart contracts. Further, there are transactional security issues that may arise.

It is desired to have secure and simplified apparatus to instantiate and transact NFTs and other transactions on a blockchain.

### SUMMARY

In accordance with embodiments, methods, apparatus and techniques are disclosed to instantiate and transact NFTs using atomic instructions and without smart contracts.

Methods, apparatus and techniques are disclosed to atomically instantiate a secure hash locked account record in association with an NFT record (a crypto-asset record) where the account record is stored in a validation layer of a blockchain and the NFT record is stored in an application layer. The secure hash locked protocol prevents a transfer of the NFT record except with a transfer of the account. The secure hash locked protocol uses first and second hashes of first and second pre-images (e.g. hash locks) to lock the account from transfer. Secure hash locked accounts may be transferred for one another using an unlock, setup and atomic swap transaction process to ensure secure transfer. Once minted, the NFT record is static and is configured to store arbitrary data useful to an external application. As an example, NFT assets may comprise digital assets such as in-game features from video games.

There is provided a first method aspect comprising: receiving a transaction request to record a digital asset comprising a non-fungible token (NFT) to a blockchain, the request received at a node of a plurality of nodes comprising a transaction network, each of the nodes maintaining respective instances of the blockchain in accordance with a consensus protocol; performing by the node in accordance with a hash locked account protocol of the transaction network: atomically instantiating an account record associated to a NFT data record in the node's instance of the blockchain, the account record recording a coin account and the NFT data record recording the NFT; and preventing a transfer of the NFT data record in the node's instance of the blockchain except in association with a transfer of the account record. Wherein, in the method, the account record comprises a secure hash locked account record associated with the NFT data record, the secure hash locked account record comprising a first hash of a first pre-image and a second hash of a second pre-image to securely lock the transfer of the account record until the first pre-image and second pre-image are provided to invoke the transfer.

In an embodiment, atomically instantiating comprises defining: a account record in a ledger of count account records; and an NFT data record in a ledger of application data records; such that a completion of the creating of one of the account record and the NFT data record is dependent upon a completion of the creating of the other one of the account record and the NFT data.

In an embodiment, the collection of account records is maintained in a validation layer of the nodes' instance of the blockchain and wherein the NFT data record is maintained in an application layer of the of the nodes' instance of the blockchain.

In an embodiment, the method comprises: in response to an unlock transaction received from a transaction initiator having control of the secure hash locked account record, unlocking the secure hash locked account record for an atomic swap to an intended receiver in exchange for an intended receiver secure hash locked account record, the unlock transaction comprising the first pre-image; and in response to an atomic setup transaction received from the transaction initiator, setting up the secure hash locked account record as unlocked for the atomic swap, the atomic setup transaction comprising the second pre-image, a new first hash H₁ for locking the secure hash locked account as setup and intended receiver data for defining the secure hash locked account record for the intended receiver upon completion of the atomic swap.

In an embodiment, the unlock transaction supplies the first preimage for verifying the first hash and a new first hash Ĥ to replace the first hash of the secure hash locked account record, wherein hash Ĥ comprises a hash of a concatenation of data comprising: the second pre-image used to generate the second hash that locks the secure hash locked account; the new first hash H₁ for use to lock the secure hash locked account record once setup, wherein H₁=hash (a new preimage P₁); and the intended receiver data comprising an intended receive account and a pair of first and second hashes H₄ and H₅ for use to lock the secure hash locked account record once transferred via the atomic swap to the intended receiver, wherein H₄ and H₅ comprise hashes of new pre-images P₄ and P₅ generated by the intended receiver.

In an embodiment, the atomic setup transaction supplies the second preimage for verifying the second hash, new first hash H₁ and the intended receiver data; and the method comprises: verifying hash Ĥ using the second preimage, new first hash H₁ and the intended receiver data; storing each of H₁ and the intended receiver data to the secure hash locked account record as set up for the atomic swap.

In an embodiment, the method comprise, in response to an atomic swap transaction received from the transaction initiator: verifying H₁; and responsive to verifying, storing the secure hash locked account record as transferred using the intended recipient data from the secure hash locked account record as setup.

In an embodiment, the method comprises, in response to respective unlocking, atomic setup and atomic swapping transaction from the intended recipient: unlocking the intended recipient secure hash locked account record using a received first preimage to verify a first hash of the intended recipient secure hash locked account record; setting up the intended receiver secure hash locked account record in preparation for the atomic swap using a received second preimage and transaction initiator data as received, the received second preimage used to verify a second hash of the intended recipient secure hash locked account record; and completing the swap to transfer the intended recipient secure hash locked account record as setup to the transaction initiator using the transaction initiator data stored to the intended recipient secure hash locked account record as setup.

In an embodiment, in accordance with the hash locked account protocol, secure hash locked account records for NFTs comprise: a field storing application metadata for use by an external application; a field each for identifying an issuer and an issuer fee to be paid upon any transfer; and a field each for an account and a refund block, the account to receive a refund should the blockchain reach the a block count of the refund block.

There is provided a second method aspect comprising: invoking a transaction request to record a digital asset comprising a non-fungible token (NFT) to a blockchain, the request communicated to a node of a plurality of nodes comprising a transaction network, each of the nodes maintaining respective instances of the blockchain in accordance with a consensus protocol and processing said transaction in accordance with a hash locked account protocol of the transaction network; wherein the transaction when performed instantiates an account record associated to a NFT data record in the node's instance of the blockchain, the account record recording an account and the NFT data record recording the NFT; wherein a transfer of the NFT data record in the node's instance of the blockchain is prevented except in association with a transfer of the account record; and wherein the account record comprises a secure hash locked account record associated with the NFT data record, the secure hash locked account record comprising a first hash of a first pre-image and a second hash of a second pre-image to securely lock the transfer of the account record until the first pre-image and second pre-image are provided to invoke the transfer.

In an embodiment, the method comprises invoking an atomic swap in the blockchain of the secure hash locked account record to transfer the NFT, the atomic swap swapping the secure hash locked account record for another secure hash locked account record following an unlocking and setup of the secure hash locked account record using the first hash and second hash and the first preimage and second preimage.

In an embodiment, the method comprises monitoring blockchain information to determine an unlocking and set up of the other secure hash locked account record before invoking the atomic swap.

In an embodiment, the method comprises receiving a first replacement hash and a second replacement hash for constructing the atomic swap to replace the first hash and the second hash to lock the secure hash locked account record as swapped.

There is provided a third method aspect for providing a digital asset by a video game service, the method comprising: invoking atomic instantiation of a digital asset comprising a non-fungible token (NFT) in a blockchain maintained by a transaction network according to a consensus protocol, the digital asset comprising an in-game feature for use by a game user in a video game, the digital asset atomically instantiated by the blockchain in an NFT record in association with a secure hash locked account record, the blockchain preventing a transfer of the NFT record without a transfer of the account record in accordance with a hash locked account protocol, the secure hash locked account record comprising a first hash of a first pre-image and a second hash of a second pre-image to secure the secure hash locked account record under control of the video game service for transferring only upon providing the first pre-image and second pre-image to the blockchain; offering the digital asset to the game user for use in the video game; invoking a transfer of the digital asset on the blockchain by instructing the transfer of the secure hash locked account record to the control of the game user, in accordance with a hash locked account protocol; and enabling use of the digital asset by the game user for use in the game.

In an embodiment, the secure hash locked account record defines a first secure hash locked account record and wherein the transfer of first secure hash locked account record performs an atomic swap of the first secure hash locked account record with a second secure hash locked account record, in accordance with the hash locked account protocol, wherein before the atomic swap the second secure hash locked account record is under control of the game user.

In an embodiment, the method comprises: invoking an unlock transaction to unlock the first secure hash locked account record; and invoking an atomic setup transaction to set up the first secure hash locked account record as unlocked for the atomic swap; wherein the unlock transaction comprises: the first pre-image; and a new hash of data 17 comprising a hash of a concatenation of: the second pre-image; a new first hash from a new first pre-image; a fourth hash from a fourth pre-image; a fifth hash from a fifth pre-image; a blockchain account number received from the game user with which to receive the transfer; metadata of the game user related to video game; wherein the fourth hash and the fifth hash are received from the game user for locking the first secure hash locked account record when transferred; wherein the new hash replacing the first hash in the first secure hash locked account as unlocked; and wherein the atomic setup transaction comprises the blockchain account number of the game user; the second pre-image; the new first hash; the fourth hash and the fifth hash; blockchain account number received from the game user; and the metadata of the game user, the fourth hash and fifth hash replacing the first hash and second hash.

In an embodiment, the method comprises invoking an atomic swap transaction in relation to the first secure hash locked account record as unlocked and as setup.

In an embodiment, invoking the atomic swap transaction is performed upon verification that the second secure hash locked account record is unlocked and set up for atomic swap.

In an embodiment, the method comprises communicating to the game user for use to unlock, setup and swap the second secure hash locked account record: the first hash; the second hash; a third hash of a third pre-image; a blockchain account number of the video game service with which to receive the transfer; and optionally metadata of the video game service related to the game the second secure hash locked account record is associated with a respective NFT.

In an embodiment, the NFT record is static upon instantiation.

In an embodiment, the NFT record comprises arbitrary application data used by the game service to enable use of the digital asset.

In an embodiment, the NFT record is stored in a ledger of an application layer of the blockchain and the secure hash locked account record is stored in a ledger of a validation layer of the blockchain.

In an embodiment, invoking atomic instantiation comprises communicating a transaction request to a first node of a plurality of nodes comprising the transaction network; and wherein, in accordance with the consensus protocol, the first node communicates the transaction for routing to each of the nodes for performing the transaction to maintain respective instances of the blockchain.

In an embodiment, the digital asset comprises instructions for a game feature.

In an embodiment, the method comprises monitoring at state of the blockchain and enabling use of respective digital assets in the video game in response to the monitoring, the respective digital assets associated with respective secure hash locked accounts.

In an embodiment, the respective digital assets are associated to respective game users via the respective secure hash locked account.

In an embodiment, the secure hash locked account record is enabled for reversion to transfer an account balance to a reversion account number stored in the secure hash locked account record, the transfer automatically performed in response to a count of blocks stored in the blockchain.

There is provided a computing device comprising a processor and a storage device storing instructions which when executed by the processor configure the computing device to perform the method of any one of method aspects provided herein.

There is provided one or more non-transient storage media computing device comprising a processor of a computing device, the instructions when executed by the processor configure the computing device to perform the method of any one of the aspects provided herein.

These and other aspects are apparent to a person of skill in the art.

### BRIEF DESCRIPTION OF THE DRAWINGS

FIG. 1 is an illustration of a network system of a plurality of computing devices in accordance with an embodiment.

FIG. 2 is a block diagram of a computing device in accordance with an embodiment.

FIG. 3 is an illustration of a network system of a plurality of computing devices in accordance with an embodiment.

FIGS. 4A, 4B and 4C are flowcharts of operations for computing devices of FIG. 3 in accordance with an embodiment.

FIGS. 5A, 5B and 5C are flowcharts of operations for computing devices of FIG. 3 in accordance with an embodiment.

FIG. 6 shows an illustration of network system of a plurality of computing devices, in accordance with an embodiment.

### DETAILED DESCRIPTION

In accordance with embodiments herein, protocol-based techniques are provided for distributed ledgers for instantiating an NFT in association with a coin record in an atomic transaction. Further, the coin is transferable via a hash locked account protocol and the transfer of the coin transfers the associated NFT. The coin record, and thus the NFT, is secured using hashed pre-images as described further. Any transfer of the coin transfers, in an atomic manner, the associated NFT. Further, a feature of a hash locked account protocol is that on a transfer, the coin associated with the NFT is indivisible—the entire coin is transferred. Hash locked accounts may also be referenced as bearer tokens or bearer token accounts and more particularly as such bearer tokens apply to NFTs, the bearer token account is a secure bearer token account as described further.

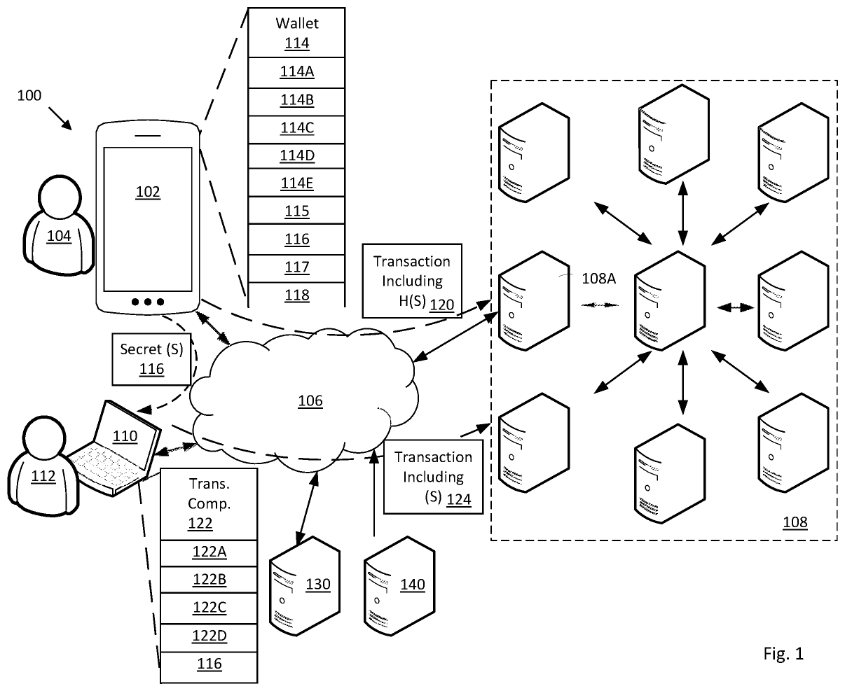

FIG. 1 is an illustration of network system 100 of a plurality of computing devices, in accordance with an embodiment. Network system 100 comprising a first user device 102 operated by a first user 104, a communication network 106, a transaction network 108 and a second user device 110 operated by a second user 112.

Also shown is a server device 130, a computing device providing a service over network 106 such as to any of devices 102 and 110. Server device 130 is not restricted to providing services to consumers or individuals. In an embodiment, services include business to business services such as is conducted with other servers or computing devices (not shown).

In accordance with an embodiment, server device 130 (e.g. server 130) provides a service (e.g. some or all of its services) in exchange for payment. In accordance with an embodiment, payment is accepted via transaction network 108. In accordance with an embodiment, other payment methods are accepted (not shown). In an embodiment, a service provided comprises an on-line gaming service (e.g. multiplayer and/or single player). In a video game service, an add-on or in-game feature comprises a digital asset and such an asset comprises any of a code for changing gameplay (e.g. a cheat code), an armor or weapon upgrade, additional in-game tokens/coins, etc. In an embodiment, an instance of such a digital asset is associated with an NFT and the NFT is instantiated and transferable via transaction network 108.

In accordance with an embodiment, server device 140 (e.g. server 140) provides a blockchain information service, providing access to at least current data of the blockchain maintained by network 108. Server 140 receives requests for data (e.g. searches) and responds with located data. Searches my comprise coin account balance searches, account locates searches, NFT or other crypto-assets searches. Data provided may be used, in an example, to construct a transaction for network 108.

The communications network 106 couples the devices for communication. Communication network 106 is simplified. In an embodiment it comprises a combination of any of public and private networks communicating using various protocols and means, whether wired or wireless. In an example, communication network 106 comprises the Internet.

In the embodiment, first user device 102 comprises a mobile device, such as a smartphone (shown), laptop, automobile, etc. Other computing device form factors are contemplated and need not be configured as a mobile device. First user device 102 comprises a wallet 114 (e.g. a mobile wallet) for facilitating transactions via the transaction network 108. In an embodiment, the mobile wallet 114 comprises a cryptocurrency wallet to manage keys 115 for cryptocurrency transactions.

In an embodiment, mobile wallet 114 provides an interface 114A to receive a secret (e.g. S comprising a pre-image of a hash lock (or hash digest) used to define a hash locked coin account) 116; an interface 114B to receive an amount 117; a hash function (e.g. H) 114C to compute a hash digest (e.g. H(S)) 118 of the secret 116 and an interface 114D to communicate the secret 116, for example to second user device 110 or server 130. Wallet 114 further provides an interface 114E to communicate a transaction 120, such as further described, including account information for a sending account, the amount 117 and the hash digest 118 to transaction network 108.

In the embodiment, second user device 110 comprises a mobile device, such as a laptop. Other computing device form factors are contemplated and second user device 110 need not be configured as a mobile device. Second user device 110 comprises a transaction configuring component 122 for facilitating transactions via the transaction network 108. In an embodiment, the transaction configuring component 122 is a browser component (e.g. a plugin or add-on, etc.) for Web-based communications. In an embodiment the transaction configuring component 122 is a wallet (not shown) such as a cryptocurrency wallet to manage keys (not shown) for cryptocurrency transactions.

In an embodiment, transaction configuring component 122 provides an interface 122A to receive a secret (e.g. S) 116 such as from first user device 102; and an interface 122B to define and communicate a transaction 124 comprising the secret S, such as further described, to transaction network 108. In an embodiment, transaction component 122 has a private/public key pair generator 122C and a key interface 122D for managing/using the keys. Devices 102 and 110 may be similarly configured to originate, consume, unlock or transfer hash locked coin accounts as further described herein.

In an embodiment, transaction network 108 comprises a plurality of interconnected nodes (each comprising respective computing devices) including a representative node 108A. In an embodiment, the transaction network 108 comprises a network implementing a distributed ledger providing a blockchain in accordance with a blockchain consensus protocol executed by the nodes to process transactions. The blockchain maintains accounts, for example, associated with keys. Cryptocurrency (e.g. coins native to the blockchain) are instantiated and maintained by the blockchain. Amounts of coins are storable to and transferable between the accounts in accordance with rules or protocols executed by the nodes for blockchain transactions. In accordance with a protocol as further described, some transactions need not be signed using a private key to be valid and instruct the transaction by the network.

In an embodiment, the blockchain records other crypto assets and facilitates transfer of same such as between accounts, which may be controlled by respective private keys. In an embodiment, crypto-assets such as NFTs are associated to respective coins that are transferable only via a secure bearer token protocol (e.g. a secure hash locked account protocol) as described further.

In an embodiment transaction network 108 comprises a payment network, which may be a blockchain network for making payments via coin, for example.

In an embodiment, each of the nodes of transaction network 108 has a same configuration for implementing the blockchain. That is, the respective nodes implement the protocols of the blockchain, though any one node may comprise different hardware, etc. Though node 108A is shown communicating with each of first and second computing devices 102 and 110, other nodes of transaction network 108 may do so in the embodiment.

In an embodiment, the transaction network implements a GeeqChain in accordance with consensus and transactions protocols of Geeq Corporation such as described in WO2019/142049 dated 25 Jul. 2019, entitled “BLOCKCHAIN METHODS, NODES, SYSTEMS AND PRODUCTS” incorporated by reference herein in its entirety. The GeeqChain provides and maintains Geeq coins—GEEQS™. In an embodiment, the transaction network implements a GeeqChain in accordance with transaction protocols of Geeq Corporation such as described in PCT/US2021/032500 filed 14 May 2021, entitled “Apparatus and Methods to Define and Use Bearer Tokens and Certified Tokens and Applications Using Bearer Tokens and Certified Tokens” incorporated by reference herein in its entirety.

In an embodiment, a first node (e.g. 108A) of the transaction network is in communication with a computing device (e.g. 102) outside the transaction network 108 where the first node receives transaction data from the computing device such as for a transaction as further described. The transaction data comprises an identification of the first node (in an embodiment). The first node communicates the transaction data within the transaction network (for example, according to a routing protocol as described further below) to facilitate processing of the transaction by other nodes of network 108 maintaining the blockchain.

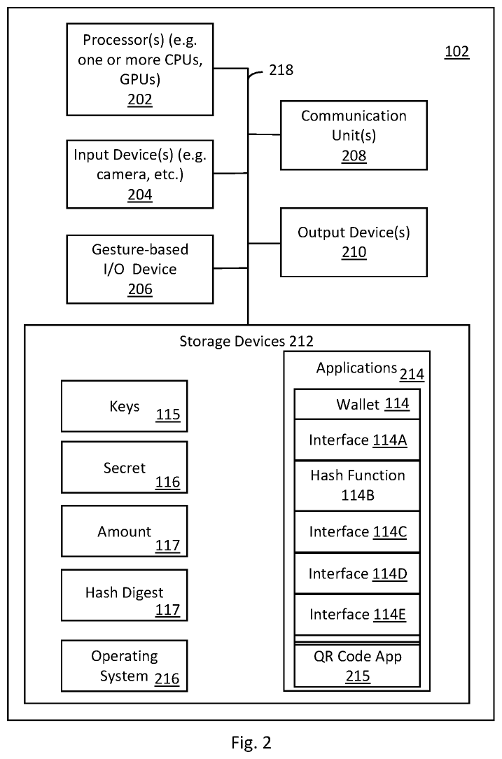

FIG. 2 is a block diagram of computing device 102, in accordance with one or more aspects of the present disclosure. Computing device 102 comprises one or more processors 202, one or more input devices 204, a gesture-based I/O device 206, one or more communication units 208 and one or more output devices 210. Computing device 102 also includes one or more storage devices 212 storing one or more modules and/or data. In an embodiment, modules include applications 214 including wallet application 114 and interfaces 114A, 114C, 114D and 114D and hash function 114B as previously described. Data includes keys 115, secret 116, amount 117, and release hash 118 as described. Wallet application 114 provides the functionality to perform transactions with transaction network 108 as described.

Storage device(s) 212 may store additional modules such as a QR Code App. to generate QR Codes for displaying and/or communicating electronically to another device such as device 110 or a printer (not shown). A module includes an operating system 216. Other modules (not shown) include communication modules; graphics processing modules (e.g. for a GPU of processors 202); map module; contacts module; calendar module; photos/gallery module; photo (image/media) editor; media player and/or streaming module; social media applications; browser module; etc. Storage devices may be referenced as storage units herein.

Communication channels 218 may couple each of the components 202, 204, 206, 208, 210, 212, and any modules for inter-component communications, whether communicatively, physically and/or operatively. In some examples, communication channels 218 may include a system bus, a network connection, an inter-process communication data structure, or any other method for communicating data.

The one or more processors 202 may implement functionality and/or execute instructions within computing device 102. For example, processors 202 may be configured to receive instructions and/or data from storage devices 212 to execute the functionality of the modules shown in FIG. 2, among others (e.g. operating system, applications, etc.) Computing device 102 may store data/information to storage devices 212. Some of the functionality is described further herein below. It is understood that operations may not fall exactly within the modules 114, etc. of FIG. 2 such that one module may assist with the functionality of another.

Computer program code for carrying out operations may be written in any combination of one or more programming languages, e.g., an object oriented programming language such as Java, Smalltalk, C++ or the like, or a conventional procedural programming language, such as the “C” programming language or similar programming languages.

Computing device 102 may generate output for display on a screen of gesture-based I/O device 206 or in some examples, for display by a projector, monitor or other display device. It will be understood that gesture-based I/O device 206 may be configured using a variety of technologies (e.g. in relation to input capabilities: resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology; and in relation to output capabilities: a liquid crystal display (LCD), light emitting diode (LED) display, organic light-emitting diode (OLED) display, dot matrix display, e-ink, or similar monochrome or color display).

In the examples described herein, gesture-based I/O device 206 includes a touchscreen device capable of receiving as input tactile interaction or gestures from a user interacting with the touchscreen. Such gestures may include tap gestures, dragging or swiping gestures, flicking gestures, pausing gestures (e.g. where a user touches a same location of the screen for at least a threshold period of time) where the user touches or points to one or more locations of gesture-based I/O device 206. Gesture-based I/O device 206 and may also include non-tap gestures. Gesture-based I/O device 206 may output or display information, such as graphical user interface, to a user. The gesture-based I/O device 206 may present various applications, functions and capabilities of the computing device 102 including, for example, wallet application 114, QR Code App. as well as any messaging applications, telephone communications, contact and calendar applications, Web browsing applications, game applications, e-book applications and financial, payment and other applications or functions among others.

Although the present disclosure illustrates and discusses a gesture-based I/O device 206 primarily in the form of a display screen device with I/O capabilities (e.g. touchscreen), other examples of gesture-based I/O devices may be utilized which may detect movement and which may not comprise a screen per se. In such a case, computing device 102 includes a display screen or is coupled to a display apparatus to present secrets and GUIs of application 114 among others. Computing device 102 may receive gesture-based input from a track pad/touch pad, one or more cameras, or another presence or gesture sensitive input device, where presence means presence aspects of a user including for example motion of all or part of the user.

One or more communication units 208 may communicate with external devices (e.g. transaction network 108 and second computing device 110) such as for the purposes as described and/or for other purposes (e.g. printing) such as via communications network 106 by transmitting and/or receiving network signals on the one or more networks. The communication units may include various antennae and/or network interface cards, chips (e.g. Global Positioning Satellite (GPS)), etc. for wireless and/or wired communications.

Input devices 204 and output devices 210 may include any of one or more buttons, switches, pointing devices, cameras, a keyboard, a microphone, one or more sensors (e.g. biometric, etc.), a speaker, a bell, one or more lights, a haptic (vibrating) device, etc. One or more of same may be coupled via a universal serial bus (USB) or other communication channel (e.g. 218). A camera (an input device 204) may be front-oriented (i.e. on a same side as) to permit a user to capture image(s) using the camera while looking at the gesture based I/O device 206. A camera may capture a secret such as text or image data.

The one or more storage devices 212 may take different forms and/or configurations, for example, as short-term memory or long-term memory. Storage devices 212 may be configured for short-term storage of information as volatile memory, which does not retain stored contents when power is removed. Volatile memory examples include random access memory (RAM), dynamic random access memory (DRAM), static random access memory (SRAM), etc. Storage devices 212, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

In an embodiment, other user oriented computing devices (e.g. 110) are similarly configured as computing device 102.

Though not shown in detail, nodes of network 108 are computing devices similar in basic construction (processors, storage devices, communication devices, input and output devices) to computing device 102 but as server-side or server like devices. That is, nodes are often are not configured with consumer oriented hardware, having fewer input and output devices, fewer user applications, a server oriented O/S, and powerful processing, storage and internal and external communications components etc.

### Hash Locked Accounts and Hash Locked Account Protocol

This section provides an initial description of basic hash locked accounts for context. In accordance with embodiments and techniques herein, bearer tokens (sometimes “BTs” or a “BT”) and certified tokens (sometimes “CTs” or a “CT” or a “bearer certificate”) may be likened to cryptographic equivalents of cash and certified checks, respectively. Another term for “Bearer Tokens” is “Hash Locked Account”.

Both BTs and CTs can be represented electronically (e.g. by text files or other data types) or non-electronically (e.g. as text or image visible on a substrate such as paper stock), which can be used to pass value (e.g. a crypto asset) from a transferor (payer or sender) to a transferee (payee or receiver) without the direct use of a blockchain or other centralized or decentralized data or financial intermediary. These tokens can be stored as text files, encoded images such as a two dimensional or three dimensional barcode (e.g. a QR Code™, a trademark of Denso Wave Incorporated, Japan), on credit, debit, or gift cards, in directories accessible to browsers through plugins or on mobile devices through apps (applications), among other ways. It is understood that QR Codes and other barcodes are useful to encode text data in accordance with the respective protocols therefor.

A bearer token is based upon knowledge and use of a secret. Bearer token data comprises a release hash digest that is generated by applying a hash function to a data value (e.g. a pre-image) chosen by a token creator that the creator keeps secret. Examples of hash functions include SHA-3 384/256, RIPEMD-160, BLAKE2 and BLAKE3.

The creator may comprise the transferor or another acting on behalf of the transferor. To create a bearer token record on the blockchain, in an embodiment, the hash digest is provide with an associated value (e.g. an amount of a cryptocurrency maintained by the blockchain) associated with an address (e.g. as sending account) controlled by the token creator. If the transaction to generate the bearer token record is valid, in an embodiment, the blockchain creates a hash locked account record (e.g. a bearer token record) with the digest and the amount, transferring the amount from the sending account. The token creator (directly or indirectly) communicates the secret to a receiver. The receiver can use the secret to release the value from the bearer token record, for example, to a receiver account. To perform a transfer a user transaction is defined including the pre-image and a receiver account designated by the receiver and sent to the blockchain (e.g. one of the nodes) to cash the bearer token. The blockchain hashes the secret and locates a matching bearer account record, if available, and in response closes the record and transfers the amount to the designated receiver account.

In an embodiment, the creator of the bearer token could choose any word, phrase, or number as a pre-image and then include the hash digest in the create bearer token account transaction. This has the advantage of being easy to remember and pass on to the receiver. On the other hand, it has the disadvantage that collisions are possible as other users happen to use the same word as a pre-image. The blockchain may be configured with a protocol to handle secret collision—e.g. where a bearer token record exists and a second request to add a record is received having the same hash digest. In an embodiment, the blockchain is configured to refuse a new create bearer token record transaction if an existing bearer token record has the same hash digest. In an embodiment, the blockchain is configured not to refuse a new create bearer token record transaction if an existing bearer token account record has the same has digest. Rather, when the secret is presented, all matching BT records are cashed. Other protocols may be adopted to handle secret collision scenarios.

In accordance with the embodiments and techniques herein, when a bearer token record is created, the blockchain moves a coin balance to a ledger entry (a form of blockchain record) that is controlled by a pre-image (the secret), rather than a private key, once the ledger entry is created. Any coin balance is moved into an “account” without an account number (the ledger entry) held in a kind of escrow waiting for transfer back to a regular account (e.g. by the sender using the secret to cash the token or by an optional expiry time as further described). The pre-image is the token needed to take control of the coins in a bearer token record. As referenced herein, a bearer token is the pre-image (secret), which may be represented (e.g. as a bearer token representation herein) in a digital or physical embodiment, off of the chain, of the coins in escrow.

In an embodiment, certified tokens comprise similar data to BTs but are further secured as described below.

Though generally described herein with reference to coin and amounts thereof, bearer token records (e.g. of any of the locked or lockable variations described) are useful with any crypto assets that has been recorded (e.g. validated correctly) on a blockchain, whether it is a cryptocurrency, tokenized asset, non-fungible token, document, contract, resource, rewards points, etc. Thus in an embodiment, a bearer token record is generated that transfers a crypto asset from a sending account to a bearer token record associated with a hash digest of a secret. The secret is associated such that presenting the secret to the blockchain completes the bearer token record to transfer the crypto asset to a receiving account. Thus where the terms “use” or “cash” the bearer token or bearer token record is recited herein in a cryptocurrency asset scenario, the term “complete” is also employed in the context of a bearer token or bearer token record where the secret is provided and the transfer is completed to a receiving account.

In an embodiment, crypto-assets of various types live on a separate application layer of the blockchain in Geeq's implementation. In other blockchains, such assets are created and controlled by smart contracts. In an embodiment, in the case of Geeq for example, an application layer token (such as an ERC20-type token, for example) a non-fungible token that represents ownership of a car or house, or even a fungible token representing partial ownership of off-chain assets like stocks, is transferred as follows: First an application layer transaction (which is wrapped in a validation layer transaction) to create a crypto-asset BAR is sent to a node. This creates a BAR on the application layer blockchain which is coded to a hash digest and is structured and used exactly like purely GEEQ coin BARs. Second, to release the app-layer BAR all that would be needed would be the pre-image. Third, fees could be prepaid when the app layer BAR (or other type of bearer token) was created, or paid by a validation layer BAR that is included in the app layer release transaction.

Example Hash Locked Account Protocol with NFT Support

Bearer tokens (e.g. the basic BT and its variants certified token and secure token) may be implemented in a variety of manners. Below is described an embodiment of bearer tokens and its variants including secure bearer tokens (e.g. which may be associated with NFTs).

The following tables Table 1 to Table 5 provide various record and transaction types and field descriptions therefor for a bearer token implementation in accordance with an embodiment. Various tables in this document show field names (“designator”), meaning of such data fields, a “Count” and a number of bytes. Count is one of “SR”, “SD” and “MO” where the letters “S”, “M”, “R”, “D” and “O” mean, “single”, “multiple”, “required”, “optional” and “depends on type”, respectively. Bytes is a length in bytes of the field.

Hash Locked Account Records are a method of transferring Coins on Geeq's VLL without needing to be in direct contact with the Node network. In an embodiment, Hash Locked Accounts have eight different Types:
HL_ATOMIC_NFT
HL_ATOMIC_SEC
HL_CERT
HL_DEAD
HL_LOCKED_NFT
HL_LOCKED_SEC
HL_STAND
HL_UNLOCKED_NFT
HL_UNLOCKED_SEC

They eight types have in common that:
Transfer and Consumption of Hash Locked Accounts are controlled through providing correct Pre-images of Locking Hashes contained in the Hash Locked Account Record kept in the VLL.
Transfer and Spending of Hash Locked Accounts is accomplished by sending, in an embodiment, a text file containing Pre-images by any means (text, email, QR code, browser extension, etc.) from the current owner to a receiver, and so does not require either a Coin Account on a GeeqChain instance or a Private Key.
Hash Locked Accounts are non-fungible and so must be Transferred or Consumed in their entirety.
Hash Locked Accounts can receive incoming Coin Transactions, for example, to receive coins with which to pay fees.
Hash Locked Account Records have no Nonce since every type of Transaction results in them either being Consumed and deleted, or deleted and replaced by a new Hash Locked Account Record.

Standard, Certified, and Secure Hash Locked Accounts are created with a Coin Balance which is deposited into other Account when the original Standard, Certified, or Secure Hash Locked Account is Consumed and deleted from the VLL. NFT Hash Locked Accounts are created in parallel (atomically) with NFT Application Layer Records by an NFT Issuer. Ownership and Transfer of the NFT is controlled by the corresponding NFT Hash Locked Account using the same basic transaction logic as Secure Hash Locked Accounts.

A Create Hash Locked Account Transaction generates a Hash Locked Account Record in the VLL in the following form of Table 1:

TABLE 1
Hash Locked Account Record

| Designator | Meaning | Count |
|---|---|---|
| groupType | =GT_HL_ACCT_REC | SR |
| blockNum | The Last Transaction Block Number. | SR |
| recStatus | Record Status. | SR |
| amtBal | The Amount to be Transferred (less Fees) to a Receiving | SR |
| | Account when Hash Locked Account Record is Consumed | |
| | or Transferred. This Balance also pays Rent and any other | |
| | Transaction Fees incurred by the Record | |
| nodeNum | The Node Number of the Issuer receiving Fees on NFT | SD |
| | Hash Locked Transactions. | |
| issuerFee | Issuer Fee for the Transactions on this Account in Micro- | SD |
| | Geeqs. This may equal zero. | |
| blockNumRfd | The Hash Locked Account Refund Block Number. | SD |
| hlDigest₁ | Hash Digest One (H₁) locks a Hash Locked Account and is | SR |
| | used as the IRN of the Hash Locked Account for a | |
| | Transaction. | |
| hlDigest₂ | Hash Digest Two (H₂) is required for Secure Hash Locked | SD |
| | Accounts. | |
| hlDigest₃ | Hash Digest Three (H₃) is required for Atomic Transfers | SD |
| acctNumReceive | The Account Number of the predesignated payee for | SD |
| | Certified Hash Locked Accounts and for Atomic Swaps | |
| acctNumSend | The Account to which the Coins held in the Hash Locked | SD |
| | Account Record is refunded when the Refund Block | |
| | arrives. | |
| metaData32 | A 32 byte MetaData field to facilitate various use cases, but | SD |
| | with no meaning within protocol. | |
| acctNumApp | IRN of the corresponding NFT Application Layer Record | SD |
| | that this NFT Hash Locked Account controls. Does not | |
| | change when the NFT Coin Record is transferred. | |

A Create Hash Locked Account Transaction is constructed by a User in accordance with Table 2:

TABLE 2
Create Hash Locked Account Transaction

| Designator | Meaning | Count |
|---|---|---|
| groupType | =GT_UNVER_APP_USER_TX | SR |
| blockNum | The Target Block Number. | SR |
| chainNum | The Target Chain Number. | SR |
| nodeNum | The Target Node Number. | SR |
| txType | Transaction Type | SR |
| nonce | The Nonce of Validation Layer Sending Account. | SR |
| amtTx | The Transaction Amount. | SR |
| blockNumRfd | The Hash Locked Account Refund Block Number. | SD |
| hlDigest₁ | Hash Digest One (H₁) is used as the IRN to create the | SD |
| | Hash Locked Account Record. | |
| hlDigest₂ | Hash Digest Two (H₂). | SD |
| acctNumReceive | The Receiving IRN that a Hash Locked Account is | SD |
| | locked to for Atomic Transfer and Certified Consume | |
| | Transactions. | |
| pubKeyUser | The Public Key of the Coin Account funding the Hash | SR |
| | Locked Account. | |
| sigUser | The Signature of the Sending Account that is Funding | SR |
| | the Creation of this Hash Locked Account on the Data | |
| | Elements above. | |

Upon receipt of the RCS containing a Valid Create Hash Locked Account Transaction, UUT, the Node does the following: OPERATION: Sending_Account_Update_Op(UUT, VLL) and creates Record with the following values:
groupTypeR=GT_HL_ACCT_REC
blockNum^{R}=Current Block
recStatus^{R}=Depends
amtBal^{R}=amtTx^{U}
blockNumRfd^{R}=blockNumRfd^{U}
hlDigest₁^{R}=hlDigest₁^{U}
hlDigest₂^{R}=Depends
hlDigest₃^{R}=Empty
acctNumReceive^{R}=Depends
acctNumSend^{R}=Hash(pubKeyUser^{U})
acctNumApp^{R}=Empty
   where the values of some elements depend of what type of Hash Locked Account Record is being created as shown in Table 3. Unmentioned fields are empty.

TABLE 3

| Hash Locked Account | |
|---|---|
| Create Type | Element Values |
| HL_CREATE_STAND_TX | recStatus^{R} = HL_STAND |
| | hlDigest₂^{R} = Empty |
| | acctNumReceive^{R} = Empty |
| HL_CREATE_CERT_TX | recStatus^{R} = HL_CERT |
| | hlDigest₂^{R} = hlDigest2^{U} |
| | acctNumReceive^{R} = acctNumReceive^{U} |
| HL_CREATE_SEC_TX | recStatus^{R} = HL_LOCKED_SEC |
| | hlDigest₂^{R} = hlDigest₂^{U} |
| | acctNumReceive^{R} = Empty |

To initiate a hash locked account, a User creates a UVT with the following fields:
txType^{U}=HL_CREATE_CERT_TX, HL_CREATE_SEC_TX, or
HL_CREATE_STAND_TX
nonce^{U}=nonce^{R} of the paying Coin Account with IRN=Hash(pubKeyUser^{U})
amtTx^{U}=Amount to be transferred into the Balance of the new Hash Locked Account
blockNumRfd^{U}=The Refund Block Number at which the Balance in the Account is returned to Hash(pubKeyUser^{U}), set to Current Block+240,000 by default
hlDigest₁^{U}=e.g. a 32 byte random number as a Pre-image and Hashes to to get this value. This may be set by a wallet application, in an embodiment.
hlDigest₂^{U}=As above, but only needed for Secure Bearer Tokens (e.g. empty otherwise)
acctNumReceive^{U}=The predesignated Receiving IRN used only for Certified Hash Locked Accounts.
pubKeyUser^{U}=Public Key for Coin Account Funding this Transaction
sigUser^{U}=Signature for the Paying Coin Account on all above including UVT header, which will also be used as the Refund Account, acctNumSendR.

The network nodes verify the Signature, and other Validity Checks, and if the Transaction passes: a) Deducts the amtTx^{U}+amtFee from the paying Coin Account with Sending_Account_Update_Op(UUT, VLL) and b) creates a New Hash Locked Account Record of the correct Type as outlined above.

In an embodiment a user wallet application is configured having an interface with controls to assist user to create transactions. In some embodiments, as described, transaction creation and communication is automatically performed, For example, when creating new Standard Hash Locked Accounts, it is expected that multiples (a plurality of accounts having a same coin amount) will be generated at the same time. In an embodiment, a user is enabled to select or input a coin amount and a count of the number of accounts to generate via transactions. In an embodiment, if a coin amount exceeds a threshold, the user is encourage or limited to creating secure hash locked accounts. TO assist with certified hash locked account transaction generation, a wallet is configured with an interface to receive the receiving account data. For example, the data may be obtained from a merchant webpage, electronic message, barcode (e.g. quick response code (“QR Code” from Denso Wave, Japan), or other manner that reduces manual input which could result in lost coins due to transfer to an incorrect receiving account. The wallet is configured, in an embodiment, to populate a refund block number that equates to a short interval (1000 block interval from the current block). In an embodiment, the refund block is selectable, for example, based on a number of days, hours, etc. The wallet stores (e.g. in a database or other storage structure) account information, pre-images for each respective account, account age, etc. The wallet is configured, in an embodiment, to communicate a preimage or images to another device for facilitating a transfer or consume transaction, for example.

Hash Locked Account Records of various Types can only be addressed with specific Hash Locked Account Transaction Types as shown in Table 4:

TABLE 4
Transaction Types Allowed to Address Hash Locked Record Types

| Hash Locked Account Record Type | Transaction Type |
|---|---|
| HL_ATOMIC_NFT | HL_ATOMIC_SWAP_TX |
| HL_ATOMIC_SEC | HL_ATOMIC_SWAP_TX |
| HL_CERT | HL_CONSUME_ CERT |
| HL DEAD | HL_REVIVE_TX |
| HL_LOCKED_NFT | HL_UNLOCK_SEC_TX |
| HL_LOCKED_SEC | HL_UNLOCK_SEC_TX |
| HL_STAND | HL_CONSUME_STAND_TX |
| HL_UNLOCKED_NFT | HL_ATOMIC_SETUP_TX |
| | HL_CONSUME_SEC_TX |
| | HL_TRANSFER_SEC_TX |
| HL_UNLOCKED_SEC | HL_ATOMIC_SETUP_TX |
| | HL_CONSUME_SEC_TX |
| | HL_TRANSFER_SEC_TX |

A Hash Locked Account Transaction is constructed by a User as follows in accordance with Table 5:

TABLE 5
Hash Locked Account Transaction

| Designator | Meaning | Count |
|---|---|---|
| groupType | =GT_UNVER_APP_USER_TX | SR |
| blockNum | The Target Block Number. | SR |
| chainNum | The Target Chain Number. | SR |
| nodeNum | The Target Node Number. | SR |
| txType | Transaction Type | SR |
| blockNumRfd | The Hash Locked Account Refund Block | SD |
| | Number. | |
| hlPreImage | Hash Pre-image that unlocks the Hash Locked | SD |
| | Account Record | |
| hlDigest₁ | Hash Digest One (H₁). | SD |
| hlDigest₂ | Hash Digest Two (H₂). | SD |
| hlDigest₃ | Hash Digest Three (H₃). | SD |
| acctNumReceive | The Account to which a Hash Locked | SD |
| | Account's Balance is paid (less Fees) when it is | |
| | Consumed. | |
| acctNumSend | The new Refund Account to which the Balance | SR |
| | is returned to when the Refund Block arrives | |
| | through an automatic Administrative Transaction. | |
| pubKeyUser | The Public Key of the Coin Account funding | SD |
| | the Hash Locked Account. Only needed for | |
| | Revive Transactions. | |
| sigUser | The Signature of the Sending Account that is | SD |
| | Funding the Creation of this Hash Locked | |
| | Account on the Data Elements above. Only | |
| | needed for Revive Transactions. | |

It will be apparent that Secure Tokens, which also are the platform for NFTs, are the only type that can be transferred or atomic swapped. Generating a Secure Token is the same as Standard Tokens (e.g. standard bearer token or certified bearer token) except for the extra Hash Lock (H₂).

All non-NFT Hash Locked Accounts include a Refund Block Number, When this Block arrives, an automatic Administrative Transaction deletes the Hash Locked Account Record from the VLL and transfers its Balance, less Fees, to the Refund Account.

NFT Hash Locked Accounts are intended to control NFTs, not to transfer Coin Balances. They are never automatically Refunded, however, they are automatically placed in Dead Status if they remain in Unlocked Status for more than 1,000 Blocks. This is because such Records may be the result of improper Node behavior and are likely to be stranded.

Since Hash Locked Transactions are not signed, malicious Nodes are able to manipulate the data elements in the transaction sent by the User. Without any user input, a node would not know P₁, the pre-image required for to create a valid Transaction. Thus, a malicious node is not able to forge a compliant transaction without a chain user first sending the node a transaction (UUT) containing P₁. A malicious node, however, could change any of the UUT header Data Elements once it sees a UUT containing P₁, submitted by the user.

For transaction processing, upon receipt of the RCS containing a valid Hash Locked Account Transaction, each node executes the Operation: Sending_Account_Update-_Op(UUT, VLL). If the balance in the account is greater than zero, each node further performs actions according to the Transaction Type.

HL_CONSUME_STAND_TX: Performs OPERATION: Receiving_Account_Update-_Op(UUT, VLL). The following example illustrates a consume transaction. Alice is the User who created or currently controls a Hash Locked Account Record. Bob is the User that Alice wishes to transfer funds or ownership of the Hash Locked Account Record to. Alice and Bob have respective computing devices for communicating with the network 108. In an embodiment, the devices are configured with respective wallet applications. Alice transmits to Bob P₁, the Pre-image of H₁=hlDigest₁, in some way. (Note that Bob is also told or knows the Identification Number of the Chain whose VLL contains the corresponding Hash Locked Account.) Bob creates and sends to the correct Chain (via a node of 108) a Consume Standard Transaction with the following fields:
txType^{U}=HL_CONSUME_STAND_TX
acctNumReceive^{U}=Bob's Receiving Account Address
hlPreImage₁^{U}=P₁

The nodes each verifies that: hlDigest₁^{R}=Hash(P₁). If so, the nodes transfer the entire Balance, less Fees, to the Receiving Account Bob chooses, and deletes the Sending Hash Locked Account Record.

Standard accounts are among the least secure and Bob may not receive the coin. For example, Alice or a Node may thwart Bob's transaction. Standard accounts are intended for small balances such that Bob's loss may be minimized. For larger amounts, Bob may require a certified account or a secure hash locked account transaction. As Standard Hash Locked Accounts are meant to contain very small balances for Micropayments, the real-world reputational damage done to Alice or the Node should be greater than the benefit of stealing a cent or two, while the loss to Bob is corresponding small. In exchange for this minor risk, all parties gain the ability to make fast, simple, low-cost Microtransactions.

HL_CONSUME_CERT_TX: Performs OPERATION: Receiving_Account_Update_Op(UUT, VLL). These operations are similar to standard hash locked account but differ because the receiving account is already named at the time of creation of the certified hash locked account. The consume transaction need not provide the receiving account data.

The following example illustrates such a consumer certified hash locked account transaction. Alice transmits P₁, to Bob in some way. Bob creates and sends to the correct node a Consume Certified Transaction with the following fields:

txType^{U}=HL_CONSUME_CERT_TX

hlPreImage₁^{U}=P₁.

The network nodes each verify that: hlDigest₁^{R}=Hash(P₁). If so, each of the nodes transfers the entire Balance, less Fees, to the Receiving Account, acctNumReceive^{R}, predesignated in the Certified Hash Locked Account Record, and the deletes the Sending Record (i.e. Alice's Certified Hash Locked Account Record).

Regarding security and trust, Bob can either trust that Alice's account exists, or he can ask a Node (or other network 108 information providing service) for proof of existence (e.g. sending a hash of the preimage to search for an account). If there does not exist a Hash Locked Account that can be accessed with P1, Bob's Transaction is invalid, and Bob gets nothing. If the account exists, however, any Consume Transaction, no matter who creates it, results in the Balance being transferred to the predesignated Receiving Account. Provided this Account is suitable to Bob, he is completely safe and will receive Balance. The safety of Certified Hash Locked Accounts comes at the cost of flexibility. Transfer of the Balance can still take place, person to person, without contact with the Chain, but the recipient must be chosen in advance when the Certified Hash Locked Account Record is created.

HL_UNLOCK_SEC_TX: Nodes each create a Record with the following (new) values:
groupType^{R}=GT_HL_ACCT_REC
blockNum^{R}=Current Block
blockNumRfd^{R}=Current Block+1,000
recStatus^{R}=Depends
amtBal^{R}=amtTx^{U}−amtFee
nodeNum^{R}=depends
issuerFee^{R}=depends
blockNumRfd^{R}=Current Block+1,000
hlDigest₁^{R}=hlDigest₁^{U}=Ĥ
hlDigest₂^{R}=hlDigest₂^{R}
hlDigest₃^{R}=Empty
acctNumReceive^{R}=Empty
acctNumSend^{R}=acctNumSend^{R}
acctNumVal^{R}=acctNumVal^{R} (For NFTs, Empty for SEC)
metadata32^{R}=depends (For NFTs, Empty for SEC)
acctNumApp^{R}=depends (For NFTs, Empty for SEC)

And if current recStatus^{R}=HL_LOCKED_NFT, then new recStatus^{R}=HL_UNLOCKED_NFT, nodeNum^{R}=new nodeNum^{R}, issuerFee^{R}=new issuerFee^{R}, metadata32^{R}=new metadata32^{R}, and acctNumApp^{R}=new acctNumApp^{R}

Else if recStatus^{R}=HL_LOCKED_SEC, then recStatus^{R}=HL_UNLOCKED_SEC and the other fields used for NFTs only are empty.

The following example illustrates the transaction. Alice either transmits P₁ and P₂ to Bob, or uses them herself to create and send an Unlock Secure Transaction to the correct node with the following fields:
txType^{U}=HL_UNLOCK_SEC_TX
hlPreImage^{U}=P₁
hlDigest₁^{U}=Ĥ

Each node verifies that hlDigest₁^{R}=Hash(P₁). If true, the nodes each delete the existing Secure Hash Locked Account Record and create a new Record in Unlocked Status with the new Hash Lock Digest One provided by Alice in her Transaction. The exact construction of hlDigest₁^{U}=Ĥ depends on the intentions of the Transaction creator regarding the new Unlocked Hash Locked Account, as described further below.

HL_CONSUME_SEC_TX: Performs OPERATION: Receiving_Account_Update_-Op(UUT, VLL) and if recStatus^{R}=HL_UNLOCKED_NFT then Deletes Record from ALL where Record_IRN(Record)=acctNumApp^{R}.

For the transaction, the User that created the Unlock Transaction chooses: hlDigest₁^{U}=Ĥ=Hash(P₂|acctNumReceive). The symbol “|” denotes a concatenation. This User creates and sends a Consume Secure Hash Locked Account Transaction with the following fields:
txType^{U}=HL_CONSUME_SEC_TX
hlPreImage^{U}=P₂
acctNumReceive^{U}=acctNumReceive.

Each node verifies that hlDigest₁^{R}=Ĥ=Hash(P₂|acctNumReceive^{U}) and hlDigest₂^{R}=H₂=Hash(P₂). If so, each of the nodes delete the existing Unlocked Hash Locked Account Record and transfers the entire Balance, less Fees, to the Receiving Account, (e.g. Bob's choice of account) acctNumReceive^{U}.

If this is an Unlocked NFT Hash Locked Account Record, the nodes also delete the associated NFT Application Layer Record as noted above (if recStatus^{R}=HL_UNLOCKED_NFT then Delete Record from ALL where Record_IRN(Record)=acctNumApp^{R}).

The Node that receives the Consume Transaction has full knowledge of the second Pre-image P₂. However, the only possible valid Transaction is a Consume Transaction directed to acctNumReceive, since only (P₂|acctNumReceive) hashes to hlDigest₁^{R}. Once a Secure Hash Locked Account Record is correctly Unlocked, the User is completely safe.

HL_TRANSFER_SEC_TX: Node creates new secure hash locked record with the following values:
groupType^{R}=GT_HL_ACCT_REC
blockNum^{R}=Current Block
recStatus^{R}=Depends
amtBal^{R}=amtBal^{R}−amtFee
nodeNum^{R}=Depends
issuerFee^{R}=Depends
blockNumRfd^{R}=Depends
hlDigest₁^{R}=hlDigest₁^{U}=H₄^{U}
hlDigest₂^{R}=hlDigest₂^{U}=H₅^{U}
hlDigest₃^{R}=Empty
acctNumReceive^{R}=Empty
acctNumSend^{R}=acctNumSend^{U}
metaData32^{R}=Depends
acctNumApp^{R}=Depends

If recStatus^{R}=
HL_UNLOCKED_NFT
   then
recStatus^{R}=HL_LOCKED_NFT
nodeNum^{R}=nodeNum^{R}
issuerFee^{R}=issuerFee^{R}
blockNumRfd^{R}=Empty
metaData32^{R}=metaData32^{U}
acctNumApp^{R}=acctNumApp^{R}.
   Else if recStatus^{R}=
HL_UNLOCKED_SEC
   then
recStatus^{R}=HL_LOCKED_SEC
nodeNum^{R}=Empty
issuerFee^{R}=Empty
blockNumRfd^{R}=blockNumRfd^{U}
metaData32^{R}=Empty
acctNumApp^{R}=Empty.

The following outlines process according to an embodiment. It is understood that:
blockNumRfd=A new Refund Block for the Transferred Secure Hash Locked Account
H₄ and H₅=New Locking Hashes which will become H1 and H2 for the Transferred Hash Locked Account
acctNumSend=A new Refund Account for the Transferred Secure Hash Locked Account
metaData32=Anything the User wishes, but most likely and ID number of the Receiving User in some use-case context.

For a record having status HL_UNLOCKED_NFT, the User that creates the Unlock Transaction chooses:

hlDigest₁^{U}=Ĥ=Hash(P₂|H₄|H₅|acctNumSend|metaData32).

For a record having status HL_UNLOCKED_SEC, the User that creates the Unlock Transaction chooses:

hlDigest₁^{U}=Ĥ=Hash(blockNumRfd|P₂|H₄|H₅|acctNumSend)

The User Creates and sends to the correct network a UVT with txType^{U}=HL_TRANSFER_SEC_TX and the following non-empty Payload fields:
blockNumRfd^{U}=blockNumRfd if recStatus^{R}=HL_UNLOCKED_SEC, and Empty otherwise
hlPreImage^{U}=P₂
hlDigest₁^{U}=H₄
hlDigest₂^{U}=H₅
acctNumSend^{U}=acctNumSend
metaData32^{U}=metaData32 if recStatus^{R}=HL_UNLOCKED_NFT and Empty otherwise.

The network nodes verify that hlDigest₂^{R}=H₂=Hash(P₂) and depending on the Data Elements in the Transfer Hash Locked Transaction:

hlDigest₁^{U}=Ĥ=Hash(P₂|H₄|H₅|acctNumSend|metaData32); or

hlDigest₁^{U}=Ĥ=Hash(blockNumRfd|P₂|H₄|H₅|acctNumSend).

If the Pre-images are correct, the network deletes the Sending Hash Locked Account

Record with Delete_Sending_Account_Update_Op(UUT, VLL). The network Creates a new Unlocked Hash Locked Account Record with the new Data Element Values taken from the Transfer Transaction.

Note that if this is an Unlocked NFT Hash Locked Account Record, the network does not need to do anything to associated NFT Application Layer Record. All that has changed is the Refund Block and Account, the Locking Hashes that control the corresponding Validation Layer Record, and the User who knows the needed Pre-images.

The Security analysis is identical to once given above for the Consume Transaction. Once a Secure Hash Locked Account Record is correctly Unlocked, the receiving User is completely safe.

HL_ATOMIC_SETUP_TX: Nodes create a Record with the following values:
groupType^{R}=GT_HL_ACCT_REC
blockNum^{R}=Current Block
recStatus^{R}=Depends
amtBal^{R}=amtBal^{R}−amtFee
nodeNum^{R}=Depends
issuerFee^{R}=Depends
blockNumRfd^{R}=blockNumRfd^{U}
hlDigest₁^{R}=hlDigest₁^{U}
hlDigest₂^{R}=hlDigest₂^{U}
hlDigest₃^{R}=hlDigest₃^{U}
acctNumReceive^{R}=acctNumReceive^{U}
acctNumSend^{R}=acctNumSend^{R}
metaData32^{R}=Depends
acctNumApp^{R}=Depends

If recStatus^{R}=
HL_UNLOCKED_NFT
   then
recStatus^{R}=HL_ATOMIC_NFT
nodeNum^{R}=nodeNum^{R}
issuerFee^{R}=issuerFee^{R}
metaData32^{R}=metaData32^{U}
acctNumApp^{R}=acctNumApp^{R}.
   Else if recStatus^{R}=
HL_UNLOCKED_SEC
   then
recStatus^{R}=HL_ATOMIC_SEC
nodeNum^{R}=Empty
issuerFee^{R}=Empty
metaData32^{R}=Empty
acctNumApp^{R}=Empty.

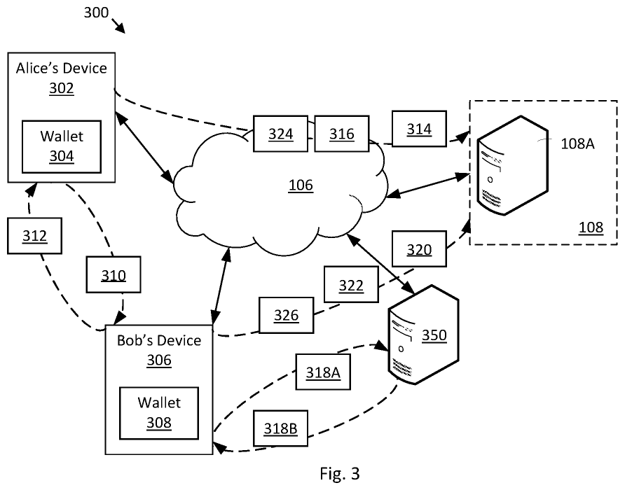

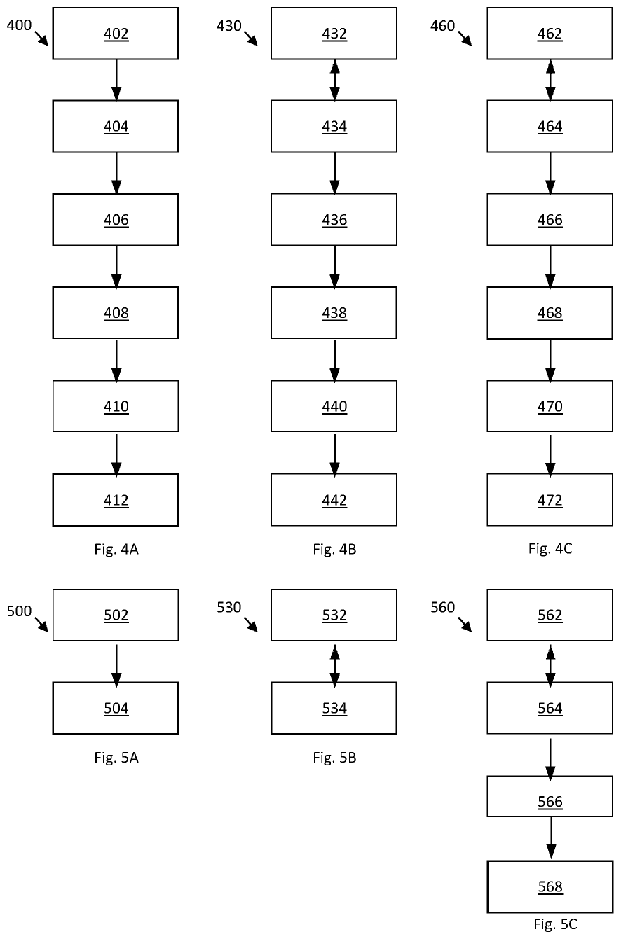

The following outlines a process according to an embodiment, and with reference to FIGS. 3, 4A, 4B and 4C. FIG. 3 shows an illustration of network system 300 of a plurality of computing devices, in accordance with an embodiment. Network system 300 comprise a first user device 302 operated by a first user (Alice, a transaction initiator, not shown), a communication network 106, a transaction network 108 and a second user device 306 operated by a second user (Bob, an intended receiver, not shown). A blockchain information service is offered by server 350 to provide at least current blockchain information in reply to queries. An information service off loads query tasks from nodes of a chain network, for example, obtaining a copy of the blockchain, which in an embodiment, can be optimized for searching.

Suppose that Alice and Bob each have either a Secure or NFT Hash Locked Account on the same or different Chains (e.g. instances of networks maintaining respective blockchains), and Alice and Bob wish to swap one for the other. Swaps can be NFT for NFT, NFT for Secure, or Secure for Secure Hash Locked Account. There is only a slight difference in Setup. In the present example, for simplicity, Alice and Bob have accounts on a same chain 108 having a representative node 108A. Each Device 302 and 306 have a wallet application 304 and 308 configured to assist with defining and communicating messages including transactions for network 108 and messages between devices 302 and 306, in accordance with an embodiment. FIG. 4A illustrates operations 400 for Alice's device, FIG. 4B illustrates operations 430 for Bob's device and FIG. 4C illustrates operations 460 for a representative node 108A of network 108 maintaining a blockchain (e.g. a Chain) in accordance with a protocol. As noted, Alice is a transaction initiator and Bob an intended recipient. In the swap, the transaction initiator receives the intended recipient secure hash locked account and the intended recipient receives the transaction initiator secure hash locked account. In either case such hash locked account can comprise an NFT hash locked account.

At 402 Alice (e.g. via wallet 304) defines data, for example, generating three new Pre-image/Hash Lock Pairs, and a Refund Block and Account Number: P₁,H₁, P₂,H₂, P₃,H₃, blockNumRfd_{A}, acctNumReceive_{A}, and if Bob has an NFT, metaData32_{A}. By default, Alice chooses blockNumRfd_{A}=Current Block+2000, according to the example. The wallet 304 assists with data creation, e.g. generating preimages, preparing hashes, block number data, etc. It is noted that Alice's existing hash locked account are secured with existing pre-images P₁ and P₂ and their hashes H₁ and H₂. The three new pairs of pre-images and hashes are expected to be new secrets and hashes.

At 432, Bob (e.g. via wallet 308) chooses two new Pre-image/Hash Lock Pairs, and a Refund Block and Account Number: P₄,H₄, P₅,H₅, blockNumRfd_{B}, acctNumReceive_{B}, and if Alice has an NFT, metaData32_{B}. (By default, Bob chooses blockNumRfd_{A}=Current Block+4000.) It is noted that Bob's existing hash locked account is locked with Bob's existing pre-images P₁ and P₂ and their hashes. The two new pairs of pre-images and hashes are expected to be new secrets and hashes.

At 404 Alice sends to Bob her unlock and setup transaction data 310 comprising new H₁, H₂, H₃, acctNumReceive_{A} (and if Bob has an NFT, metaData32_{A}) and Bob receives at 434. At 436, Bob sends to Alice his unlock and setup transaction data 312 comprising new H₄, H₅, acctNumReceive_{B} (and if Alice has an NFT, metaData32_{B}) and Alice receives at 406.

At 408 Alice Unlocks her Account with an unlock transaction 314 (HL_UNLOCK_-SEC_TX). Alice supplies existing preimage P₁ in the unlock transaction and a new hash Ĥ from new secret and new hashes to set a new hash lock from data known to Alice and Bob, where the Unlock transaction 314 comprises:

hlDigest₁^{U}=Ĥ=Hash(blockNumRfd_{A}|P₂|H₁|H₄|H₅|acctNumReceive_{B}|metaData32_{B}),

where metaData32_{B} is included only if Alice is Swapping an NFT to Bob. In the resulting unlocked record, hlDigest₂^{R}=hash (existing P₂), where existing P₂ is known only to Alice.

Following receipt (not shown) according to a transaction bundling and routing protocol, at 462, each network node (e.g. 108A) unlocks Alice's Account following verification processes as previously described (effectively creating a new unlocked account).

At 410, Alice Creates (via wallet 304) and sends to the correct Chain (e.g. network 108) a UVT (transaction 316) with txType^{U}=HL_ATOMIC_SETUP_TX and the following non-empty Payload fields:
blockNumRfd^{U}=blockNumRfd_{A}
hlPreImage^{U}=existing P₂ where hash (P₂) was used to lock Alice's original account record.
hlDigest₁^{U}=H₁ (i.e. new H₁)
hlDigest₂^{U}=H₄ (i.e. new H₄)
hlDigest₃^{R}=H₅ (i.e. new H₅)
acctNumReceive^{U}=acctNumReceive_{B}
metaData32^{U}=metaData32_{B} if recStatus^{R}=HL_UNLOCKED_NFT and Empty otherwise.

Following receipt (not shown) according to a transaction bundling and routing protocol, at 464, each network node (e.g. 108A) verifies that:

hlDigest₁^{R}=Ĥ=Hash(blockNumRfd_{A}|P₂|H₁|H₄|H₅|acctNumReceive_{B}|metaData32_{B})

hlDigest₂^{R}=H₂=Hash(P₂),

where metaData32_{B} is included only in the case of an NFT Hash Looked Record. That is, hlDigest₁^{R}=H was set in response to the unlock transaction providing Ĥ. In the setup transaction, Alice provides existing hlPreImage^{U}=P₂ and new hashes H₁, H₄ and H₅ so that hlDigest₁^{R} of the unlocked account record can be verified by the node.

If so verified, each network node at 466 deletes Alice's Sending Hash Locked Account Record with Delete_Sending_Account_Update_Op(UUT, VLL) and Creates a new Atomic Hash Locked Account Record with the new Data Element Values taken from the Atomic Setup Transaction. That is where, hlDigest₁^{R}=H₁ is what Alice sent, hlDigest₂^{R}=H₄, and hlDigest₃^{R}=H₅.

At 438, Bob checks Alice's network records (e.g. via a node inquiry or via an information service inquiry 318A (e.g. to an information service provided by server 350) providing information (e.g. via reply 318B) about the blockchain) to verify that Alice's Account is in Atomic Status, acctNumReceive_{B} is the Receiving Account, H₁ is the new H₁ that Alice sent, hlDigest₂^{R}=H₄, and hlDigest₃^{R}=H₅ (and metaData32^{R}=metaData32_{B} if Alice is Swapping an NFT to Bob).

If so, at 440, Bob Unlocks his Account with an unlock transaction 320. The transaction 318 comprises Bob's existing pre-image P₁ to match when hashed to Bob's existing H₁ in Bob's account record when it was instantiated and:

hlDigest₁^{U}=H=Hash(blockNumRfd_{B}|P₂|H₁|H₂|H₃|acctNumReceive_{A}|metaData32_{A}),

where metaData32_{A} is included only if Bob is Swapping an NFT to Alice. P₂ here is Bob's existing pre-image used to define existing H₂=hash (existing P₂) in Bob's account record.

Following receipt (not shown) according to a transaction bundling and routing protocol, at 468, each network node (e.g. 108A) unlocks Bob's Account as previously described (effectively creating a new unlocked account) according to the protocol. After the unlock, Bob's account record will have hlDigest₁^{R}=Ĥ and hlDigest₂^{U}=existing H₂.

At 442, Bob Creates and sends to the correct Chain (correct network 108 from a plurality of such networks that maintain respective chains) a UVT 322 with txType^{U}=HL_ATOMIC_SETUP_TX and the following non-empty Payload fields:
blockNumRfd^{U}=blockNumRfd_{B}
hlPreImage^{U}=existing P₂
hlDigest₁^{U}=new H₁ from Alice
hlDigest₂^{U}=new H₂ from Alice
hlDigest₃^{R}=new H₃ from Alice
acctNumReceive^{U}=acctNumReceive_{A}
metaData32^{U}=metaData32_{A} if recStatus^{R}=HL_UNLOCKED_NFT and Empty otherwise.

Following receipt (not shown) according to a transaction bundling and routing protocol, at 470, each network node (e.g. 108A) verifies that:

hlDigest₁^{R}=H=Hash(blockNumRfd_{B}|P₂|H₁|H₂|H₃|acctNumReceive_{A}|metaData32_{A}); and
hlDigest₂^{R}=existing H₂=Hash(existing P₂),
   where metaData32_{A} is included only in the case of an NFT Hash Looked Record.

The following explanation from the point of view of Bob also applies to Alice's account record unlocking and set up with Alice's existing data referenced for her account record. Existing P₁ from Bob's locked account proves Bob owns his account record. Ĥ is substituted for the existing H₁ at unlock, and includes existing P₂ from the locked account as part of the concatenation that is hashed. It is desired that only Bob is able to execute an atomic setup TX of Bob's unlocked account record. Once Bob provides exiting P₁ to a node, the node could do its own unlock with any data it wished. It could then send this data for the set up TX and this would hash to Ĥ. What prevents that is that the node does not know Bob's P₂, only bob does. Thus, only Bob could generate Ĥ which includes a hash of existing P2. Since existing H₂ is still part of the unlocked record, Bob and only Bob, using existing P2 that hashes to H₂, can create a valid Ĥ.

At 472, if so verified, the Chain deletes Bob's Sending Hash Locked Account Record with Delete Sending_Account_Update_Op(UUT, VLL) and creates a new Atomic Hash Locked Account Record with the new Data Element Values taken from the Atomic Setup Transaction.

Though not shown, Alice and Bob's wallet applications may query server 350, by way of example, to verify their respective transactions were processed.

The Security analysis is identical to one given above for the Consume Transaction. There is no security risk once the locked Hash Locked Account Record is correctly Unlocked.

Note that Atomic Setup Transactions create a Validation Layer IRN since there must be two Hash Locked Accounts sharing the same First Hash Lock to make an Atomic Swap possible. As a result, Atomic Setup Transactions only need to be checked to make sure there is no Validation Layer IRN Collision with Hash Locked Records in Non-Atomic Status.

HL_ATOMIC_SWAP_TX: Nodes create a Record with the following values:
groupType^{R}=GT_HL_ACCT_REC
blockNum^{R}=Current Block
recStatus^{R}=Depends
amtBal^{R}=amtBal^{R}−amtFee
nodeNum^{R}=Depends
issuerFee^{R}=Depends
blockNumRfd^{R}=Depends
hlDigest₁^{R}=hlDigest₂^{R}
hlDigest₂^{R}=hlDigest₃^{R}
hlDigest₃^{R}=Empty
acctNumReceive^{R}=Empty acctNumSend=acctNumReceive
metaData32=Depends
acctNumApp^{R}=Depends.

If recStatus^{R}=
HL_ATOMIC_NFT
   then
recStatus^{R}=HL_LOCKED_NFT
nodeNum^{R}=nodeNum^{R}
issuerFee^{R}=issuerFee^{R}
blockNumRfd^{R}=Empty
metaData32v=metaData32^{R}
acctNumApp^{R}=acctNumApp^{R}.

Else if recStatus^{R}=
HL_ATOMIC_SEC
   then
recStatus^{R}=HL_LOCKED_SEC
nodeNum^{R}=Empty
issuerFee^{R}=Empty
blockNumRfd^{R}=Current Block+240,000
metaData32^{R}=Empty
acctNumApp^{R}=Empty.

The following outlines a process according to an embodiment, and with reference to FIGS. 3, 5A, 5B and 5C. FIG. 5A illustrates operations 500 for Alice's device, FIG. 5B illustrates operations 530 for Bob's device and FIG. 5C illustrates operations 560 for a representative node 108A of network 108. Carrying on the example of FIGS. 4A, 4B and 4C, Alice is the initiator and Bob is the intended recipient.

Both Alice's and Bob's Account begin in Atomic Status (following respective Atomic Setup described with reference to FIGS. 3, 4A, 4B and 4C). Bob has already checked that Alice's Account Data Elements are as they should be (e.g. at 438).

At 502, Alice checks Bob's network's information to verify that Bob's Account is in Atomic Status, acctNumReceive_{A} is the Receiving Account, H₁ is what she sent, hlDigest₂^{R}=H₂, hlDigest₃^{R}=H₃, (and metaData32^{R}=metaData32_{A} if Bob is Swapping an NFT to Alice). Alice sends a query and receives a reply from the chain information service of server 350 to check the account data (not shown in FIG. 3 for simplicity).

If so verified, at 504 Alice Creates and sends to Bob's Chain (in the example, the same as Alice's) a UVT 324 with txType^{U}=HL_ATOMIC_SWAP_TX and the following non-empty Payload field: hlPreImage^{U}=P₁. Here P₁ is the new P₁ associated to new H₁.

Following receipt (not shown) according to a transaction bundling and routing protocol, at 562, each network node (e.g. 108A) verifies that hlDigest₁^{R}=Hash(P₁).

If so verified, at 564, each network node deletes Bob's Sending Atomic Hash Locked Account Record with Delete_Sending_Account_Update_Op(UUT, VLL) and Creates a new Locked Hash Locked Account Record with the new Data Element Values taken from the existing Record. In Alice's received Record, hlDigest₁^{R}=H₂ and hlDigest₂^{R}=H₃. Field hlDigest₁^{R} is empty.

At 532 Bob verifies results of Alice's swap transaction 324 (e.g. wallet 308 queries information service of server 350 (query not shown in FIG. 3 for simplicity), which includes P₁ as a Data Element, in Alice's Chain. At 534 Bob Creates and sends to the correct Chain a UVT 326 with txType^{U}=HL_ATOMIC_SWAP_TX and the following non-empty Payload field: hlPreImage_{U}=P₁.

Following receipt (not shown) according to a transaction bundling and routing protocol, at 566, each network node (e.g. 108A) Verifies that hlDigest₁^{R}=Hash(P₁).

If so verified, at 568 each network node deletes the Alice's Sending Atomic Hash Locked Account Record with Delete_Sending_Account_Update_Op(UUT, VLL) and Creates a new Locked Hash Locked Account Record with the new Data Element Values taken from the existing Record. In Bob's record hlDigest₁^{R}=H₄ and hlDigest₂^{R}=H₅, the other digest field being empty.

Though not shown, Alice and Bob's wallet applications may query server 350, by way of example, to verify their respective transactions were processed.

It will be noted that in an Atomic Swap, Alice cannot claim Bob's Account without revealing the Pre-image to H₁, which then allows Bob to Claim Alice's Account anytime before its Refund Block.

The Security analysis is identical to one given above for the Consume Transaction. Note that it does not matter who creates the Swap Transaction, the result is the same. There is no security risk once the locked Hash Locked Account Record is correctly Unlocked.

The operations of FIGS. 4A-4C and 5A-5C show various method aspects and embodiments. It will be apparent that in an embodiment, in response to an unlock transaction received from a transaction initiator (e.g. Alice) having control of a secure hash locked account record (e.g. having an NFT), a method such as performed by a node of the network 108 comprises unlocking the secure hash locked account record for an atomic swap to an intended receiver (e.g. Bob) in exchange for an intended receiver secure hash locked account record. The unlock transaction comprises a first pre-image. Further, in response to an atomic setup transaction received from the transaction initiator, the method comprises setting up the secure hash locked account record as unlocked for the atomic swap. The atomic setup transaction comprises the second pre-image, a new first hash H₁ for locking the secure hash locked account as setup and intended receiver data (e.g. from Bob) for defining the secure hash locked account record for the intended receiver upon completion of the atomic swap.

In an embodiment, the unlock transaction supplies the first preimage for verifying the first hash and a new first hash H to replace the first hash of the secure hash locked account record. Hash H comprises a hash of a concatenation of data comprising: the second pre-image used to generate the second hash that locks the secure hash locked account; the new first hash H₁ for use to lock the secure hash locked account record once setup, wherein H₁=hash (a new preimage P₁); and the intended receiver data comprising an intended receive account and a pair of first and second hashes H₄ and H₅ for use to lock the secure hash locked account record once transferred via the atomic swap to the intended receiver. H₄ and H₅ comprise hashes of new pre-images P₄ and P₅ generated by the intended receiver.

In an embodiment, the atomic setup transaction supplies the second preimage for verifying the second hash, new first hash H₁ and the intended receiver data; and the method comprises: verifying hash Ĥ using the second preimage, new first hash H₁ and the intended receiver data; storing each of H₁ and the intended receiver data to the secure hash locked account record as set up for the atomic swap.

In an embodiment, the method comprises, in response to an atomic swap transaction received from the transaction initiator: verifying H₁; and responsive to verifying, storing the secure hash locked account record as transferred using the intended recipient data from the secure hash locked account record as setup.

The node also performs method operations in respect of Bob's account record (the intended recipient secure hash locked account record). In an embodiment, the method comprises, in response to respective unlocking, atomic setup and atomic swapping transaction from the intended recipient: unlocking the intended recipient secure hash locked account record using a received first preimage (e.g. Bob's existing P₁) to verify a first hash of the intended recipient secure hash locked account record; setting up the intended receiver secure hash locked account record in preparation for the atomic swap using a received second preimage (e.g. Bob's existing P₂) and transaction initiator data as received, the received second preimage used to verify a second hash of the intended recipient secure hash locked account record; and completing the swap to transfer the intended recipient secure hash locked account record as setup to the transaction initiator using the transaction initiator data stored to the intended recipient secure hash locked account record as setup.

In an embodiment, in accordance with the hash locked account protocol, secure hash locked account records for NFTs comprise: a field storing application metadata for use by an external application; a field each for identifying an issuer and an issuer fee to be paid upon any transfer; and a field each for an account and a refund block, the account to receive a refund should the blockchain reach the a block count of the refund block.

HL_ATOMIC_REVIVE_TX: Nodes perform OPERATION: Receiving_Account_Update-_Op(UUT, VLL) and create a Record with the following values:
groupType^{R}=GT_HL_ACCT_REC
blockNum^{R}=Current Block
recStatus^{R}=HL_LOCKED_NFT
amtBal^{R}=amtBal^{R}−amtFee
nodeNum^{R}=nodeNum^{R}
issuerFee^{R}=issuerFee^{R}
blockNumRfd^{R}=Empty
hlDigest₁^{R}=hlDigest₁^{U}
hlDigest₂^{R}=hlDigest₂^{U}
hlDigest₃^{R}=Empty
acctNumReceive^{R}=Empty
acctNumSend^{R}=acctNumSend^{R}
metaData32^{R}=metaData32^{R}
acctNumApp^{R}=acctNumApp^{R}

The following is an example process.

The Refund Block arrives for a Locked or Atomic Hash Locked NFT Record. An automatic Administrative Transaction Administrative Transaction changes the Record Status from Unlocked or Atomic NFT to HL_DEAD.

The User with the Private Key that corresponds to acctNumSend^{R} Creates and sends to the correct network a UVT with txType^{U}=HL_ATOMIC_REVIVE_TX and the following non-empty Payload fields:
hlDigest₁^{U}=H₁
hlDigest₂^{U}=H₂
hlDigest₃^{U}=hlDigest₁^{R}
pubKeyUser^{U}=pubKeyUser
sigUser^{U}=sigUser
   where H₁ and H₂ are new Hash Locks with Pre-images known to Alice.

The network checks that the Signature is correct and acctNumSend^{R}=Hash (pubKeyUser^{U}).

If so, the network deletes the Dead Hash Locked Account Record and Creates a new Locked Hash Locked NFT Record with the new Data Element values taken from the Revive transaction.

The following are two reasons why the Refund Block would arrive without the User completing his intended transaction. I) The receiving Node (improperly) uses P₁ to Unlock the Account with and some hash of its own choosing. This makes it impossible for any Actor to execute a Transaction on the Account. II) The counterparty to an Atomic Transfer never completes her part, and so does not reveal the needed Pre-image.

If a Hash Locked NFT Account was simply refunded, as for Non-NFT Hash Locked accounts, then the Application Layer NFT Record would also be deleted.

The Revive Transaction allows the User to recover control of the NFT instead of just receiving a refund of the Coin Balance in the Hash Locked Account, by giving it two new Hash Locks but otherwise returning it to its initial Locked State.

As pointed out above, the receiving Node could discard Alice's or Bob's Unlock Transaction and create a new one using P₁ and some hash of its own choosing. The Node, however, would not know Alice's P₂, and without this, would not be able create a valid Transaction for the Unlocked Account Record. The Account Record transitions to Dead Status as a result.

Alice's original Refund Account, acctNumSend^{R} remains part of the Record, and only Alice should know the corresponding Public/Private Key Pair. Thus, only Alice is able to create a valid Revive Transaction that resets the two Hash Locks and returns the Record to HL_LOCKED_NFT status.

Note that this procedure cannot be used by Alice to front run any Swap or Transaction since it can only be used after a Record has been Locked for 1,000 Blocks and transitioned to Dead Status.

In an embodiment, Wallet functions are provided to assist with such transactions (e.g. Atomic Setup, Swap and Revive, among others). For example the wallet is enabled to communicate to receive blockchain information checking to see that a particular Hash Locked Account exists, and that a Transaction was successful. Failed Standard and Secure Token Transactions may only require notifying the User. Unlocking Secure Hash Locked Records is more complicated. The hash is composed differently for different types of transactions as noted above. For simple Consumption, the User only need to supply a Receiving Account, so this is no more complex than a standard Coin Transactions (all the same issues of getting the Receiving Account right).

For Transfers, the Wallet can be enabled to, either: i) Send the two Pre-images and let the Receiver Unlock; or ii) Ask the Receiver to supply acctNumSend and two Hash Locks and then create the Unlock Transaction and Transfer Transaction locally. A wallet function to mirror option i) is a configuration which receives two Pre-images (e.g. from a sending wallet) and prepares Unlock and Transfer Transactions immediately to prevent front running. The Receiving wallet is enabled to permit a user to choose or have a preconfigured acctNumSend.

For Atomic Setup, there is communication with another User, or at least with such user's Wallet, to agree on new Hash Locks and other data need to make the atomic setup function. For example, the Wallet communicates to obtain blockchain information to make sure the counterparty Account is correctly primed. The Wallet should execute its side of the Setup only when there is confirmation. Confirmation may automatically trigger the corresponding setup transaction. A counterparty Wallet should communicate for the setup to become aware of this state, and then execute the Swap, which may be automatic on confirmation. Similarly, the other Wallet must confirm the swap initiation, determine (e.g. locate or receive) the Pre-image used, and complete its side of the Swap transaction, which may be automatic on confirmation. Any automatic transaction may be enabled to proceed only after user agreement (e.g. provide input to proceed). Users may be prompted to select among accounts (e.g. refund accounts), if applicable. Initial (new) Pre-images, Hashes of same and the Refund Block may be determined by the wallet without User input, in an example. In an embodiment, user input is received when generating preimages (e.g. for randomness).

A Wallet, in an example, is enabled to detect a failed Unlock, notify a user and prepare and/or communicate, such as on user input, a Revive Transaction after the Hash Locked Account goes to Dead Status.

### Proxy Accounts

In accordance with an embodiment, the blockchain provides a protocol for establishing and using a proxy account. Proxy Accounts extend the ways that Coins can be used and transacted. In an embodiment, there are five types of proxy accounts, one of which relates to NFTs, namely Proxy_NFT_Mint.

Proxy NFT Mint Account Records are created by an AdminUser (also referred to as an Issuer) who desires to issue Application Layer NFT Records under the AdminUser's PPK signature. This Proxy Account is used by the AdminUser to fund an initial Account Balance and Transactions Fees for Minting NFTs, and does not allow for MultiUsers. NFT Mint Transactions are always funded by an NFT Mint Proxy Account. Only the AdminUser can Mint NFTs, but the Proxy Record is not tied to a specific Application Layer NFT Record since these NFT Records cannot be altered once they are created. An Issuer may join the node account record (NAR) as a node to if the Issuer desires to collect extra Fees for User transactions on NFTs they mint (create) using the Proxy NFT Mint Account. A Proxy NFT Mint Account permits an Issuer to mint Application Layer NFT records attached to either an NFT Coin or Hash Locked Accounts.

The Create Account Proxy Transaction generates one of five Types of Account Records in the validation layer ledger (VLL) and may also generate one of two Types of Application Layer Records. Tables 6 and 7 below show a Proxy Account Record and a Proxy Account Record Creation Transaction, respectively. It will be understood that some data elements in the tables relate to only some of the proxy types.

TABLE 6
Proxy Account Record

| Designator | Meaning | Count |
|---|---|---|
| groupType | =GT_PROXY_ACCT_REC. | SR |
| blockNum | The Last Transaction Block Number. | SR |
| Nonce₁ | The Nonce of the Validation Layer Record for | SR |
| | MultiSig records, or the nonce of the AdminUser for | |
| | all other Record types. | |
| recStatus | Record Type | SR |
| amtBal | The Account Balance of Coins in this Record. | SR |
| acctNumVal | The IRN of this Validation Layer Record. | SR |
| acctNumAdminUser | The Hash of the Public Key for the AdminUser | SD |
| | connected with this Record. NOTE: May or may not | |
| | have an existing Coin Account in the VLL. | |
| SigTheasholdNum | The number of Signatures needed for a Transaction to | SD |
| | be Valid. | |
| count8 | The number of acctNumMultiUser Data Elements | SR |
| | that follow. | |
| acctNumMultiUserₙ | Hashes of the Public Keys for non-Administrative | MD |
| | MultiUsers connected with a Proxy Record. NOTE: | |
| | May or may not have an existing Coin Account in the | |
| | VLL. Not applicable for NFT. | |
| nonceₙ | Nonce for each MultiUser listed above in the same | MD |
| | order. These Nonces are indexed n = 2 through count8 + 1 ≡ N. | |
| pubKeyUser | Public Key used to sign and authenticate NFT | SD |
| | Records on the Application Layer. | |
| acctNumApp | The IRN of Application Layer Record this Proxy | SD |
| | Record can pay Transaction Fees for, may control | |
| | transaction permissions for. | |

TABLE 7
Proxy Account Record Creation Transaction

| Designator | Meaning | Count |
|---|---|---|
| groupType | GT_UNVER_VAL_USER_TX | SR |
| blockNum | The Target Block Number. | SR |
| chainNum | The Target Chain Number. | SR |
| nodeNum | The Target Node Number. | SR |
| txType | Transaction Type. | SR |
| nonce | The Nonce of the Validation Layer Sending Account. | SR |
| amtTx | The Transaction Amount. | SR |
| nodeNum | Node number of Issuer receiving fees | SD |
| issuerFee | Issuer Fee for the Transactions on this Account in | SD |
| | MicroGeeqs | |
| acctNumAdminUser | The hash of the Public Key for the AdminUser | SD |
| SigTheasholdNum | The number of Signatures needed for a Transaction to | SD |
| | be Valid. (e.g. for Mult-Sig) | |
| count8 | The number of acctNumMultiUser Data Elements | MR |
| | that follow. | |
| acctNumMultiUserₙ | Hashes of the Public Keys of non-Admin Users | MO |
| | connected with this Record. (not applicable for NFT) | |
| acctNumApp | IRN of the Application Layer Record (DCE, Smart | SD |
| | Contract) that is Created along with this Proxy | |
| | Record | |
| pubKeyUser | Public Key of the User creating and funding this | SR |
| | Proxy Account Record. This is also used as the Public | |
| | Key that endorses NFTs for NFT Mint Proxy | |
| | Accounts that might be Created. | |
| sigUser | The Signature of the Sending Account that is funding | SR |
| | the Proxy Account Record Creation on the Data | |
| | Elements above. | |

In an embodiment, upon receipt of a relay content statement (RCS) comprising transactions for processing by a node in network 108 containing a Valid Create Account Proxy Coin Transaction, the Node executes the Operation: OPERATION: Sending_Account_-Update_Op(UUT, VLL) and Creates a Record with the following values:
groupType^{R}=GT_PROXY_ACCT_REC
blockNum^{R}=Current Block
nonce=1
recStatus^{R}=Depends
amtBal^{R}=amtTx^{U}
acctNumVal^{R}=acctNumVal^{U}
acctNumAdmin^{R}=Depends
SigTheasholdNum^{R}=Empty for NFT account
count8^{R}=count8^{U}
acctNumMultiUserₙ^{R}=Empty for NFT account
nonceₙ^{R}=Empty for NFT account
pubKeyUser^{R}=Depends
acctNumApp^{R}=Depends
   where the Value of “Depends” Data Elements depend on the type of Proxy Account Record being created. For a Proxy Create Mint, transaction logic provides:
recStatus^{R}=PROXY_NFT_MINT
SigTheasholdNum^{R}=Empty
acctNumAdmin^{R}=acctNumAdmin^{U}
acctNumMultiUser^{R}=Empty
nonce^{R}=Empty
pubKeyUser^{R}=pubKeyUser^{U}
acctNumApp^{R}=Empty

NFT Mint Records allow Issuers to create NFTs for which they can charge Fees. To enable this feature, the Issuer also executes a Join NAR Transaction using the Public Key above.

To initiate such activities in the node, a User creates a new transaction with the following Payload fields:
txType^{U}=PROXY_CREATE_MINT_TX,
nonce^{U}=nonce^{R} of the paying Coin Account with IRN=Hash(pubKeyUser^{U})
amtTx^{U}=Amount to be transferred into the Balance of the new Proxy Account
acctNumVal^{U}=Validation IRN Chosen by User (e.g. a Random Number) as the IRN for Newly Created Proxy Account Record.
SigTheasholdNum^{U}≤count8^{U} and only non-empty for PROXY_CREATE_-MULTISIG_TX
acctNumAdmin^{U}=Hash of some Public Key. It may be preferred that this should also be an existing Coin Account in case the AdminUser deletes the Proxy Account and needs a refund, but such is not required.
count8^{U} must equal zero for PROXY_CREATE_MINT_TX
acctNumMultiUser^{U}=Hashes of Public Keys, Need not be an existing Coin Account IRN (not applicable for NFT Mint).
acctNumApp^{U}=Empty for PROXY_CREATE_MINT_TX.
pubKeyUser^{U}=Public Key for Coin Account Funding this Transaction
sigUser^{U}=Signature for the Paying Coin Account on all above including transaction header

The Chain verifies the Signature, and other Validity Checks, and if the Transaction passes: each Node deducts the amtTx^{U}+amtFee from the paying Coin Account with Sending_Account_Update_Op(UUT, VLL) and creates a New Proxy Account Record of the correct Type as outlined above.

In an embodiment, a wallet is configured to enable such transactions, for example, via drop down or other User interface constructs. The wallet is configured to generate key pairs such as using known algorithms, for multi users if applicable and generate a random number for acctNumVal IRN, etc.

In an embodiment, Proxy Account Records of various Types can only be addressed with specific Proxy Account Transaction Types. For Proxy_NFT_Mint, the type is delete record only (PROXY_DELETE_REC_TX).

Table 8 shows a Proxy Transaction:

TABLE 8
Proxy Transaction

| Designator | Meaning | Count |
|---|---|---|
| groupType | =GT_UNVER_VAL_USER_TX | SR |
| blockNum | The Target Block Number. | SR |
| chainNum | The Target Chain Number. | SR |
| nodeNum | The Target Node Number. | SR |
| txType | Transaction Type | SR |
| nonce | Nonce1 in the Proxy Record that is specific to the | SR |
| | AdminUser. | |
| acctNumVal | IRN of a ProxyAcctRec. | SR |
| acctNumMultiUser | Hash of the Public Key a non-AdminUser to be added | SD |
| | or removed from Record. | |
| pubKeyUser | Public Key of the AdminUser of this Account. | SR |
| sigUser | The Signature of the AdminUser for this Transaction | SR |
| | on the Data Elements above. | |

In an embodiment, upon receipt of a relay content statement (RCS) comprising transactions for processing by each node in network 108 containing a Valid Proxy AdminUser Transaction, each node executes the Operation: OPERATION: Sending_Account_Update_Op(UUT, VLL). The following is further performed by each node, responsive to a PROXY DELETE REC transaction type: OPERATION: Receiving_Account_Update_Op(UUT, VLL).

Deleting an NFT Mint Proxy Account does not affect the Application Layer NFTs already Minted since each is associated with its own Hash Locked NFT Record created at the same time the NFT was issued.

To create a proxy account transaction, a User Creates an unverified validation layer transaction (UVT) with the following Payload fields:
txTypeU=PROXY_ADD_TX, PROXY_DELETE_REC_TX, or PROXY_REMOVE_TX
nonce^{U}=nonce₁^{R} of the AdminUser in the Proxy Account with IRN=acctNumVal^{R} acctNumVal^{U}=acctNumVal^{R} of the Proxy Account being addressed,
acctNumMultiUser^{U}=a hash of a Public Key of an existing MultiUsers to be removed, or a new MultiUser to be added to the Proxy Account.
pubKeyUser^{U}=Public Key of the AdminUser.
sigUser^{U}=Signature for the AdminUser.

The nodes of the network each verify the Signature, and other Validity Checks, and if the Transaction passes: a. Deducts the amtFee from the Proxy Account Balance Sending_Account_Update_Op(UUT, VLL) and b. If this is a PROXY_DELETE_REC_TX Transaction, deletes the Proxy Account, and credits the remaining Account Balance, less fees to the Account having IRN=Hash(pubKeyUser^{U}) with Receiving_Account_Update_Op(UUT, VLL).

### Application Layer Transactions and NFT Records

In an embodiment, blockchain users (e.g. via devices 102, 110, etc.) prepare and submit application layer related transactions to a node (e.g. 108A) of the network 108. In an embodiment, any node of network 108 may receive such transactions and a similar approach applies to validation layer related transactions. Nodes receive such transactions and process them in association with a consensus protocol for the network to build the blockchain in blocks.

Each node that receives respective transactions performs a preprocessing (e.g. sanity check for well-formed transaction correctness) before grouping the respective transactions into a respective node content statement (NCS) for forwarding. These respective grouped transactions are communicated for distribution about the network in accordance with the consensus protocol. In an embodiment, a network implementing GeeqChain follows a hub and spoke methodology for gathering and routing transactions for next block processing by nodes of the network. A Relay (e.g. one of the nodes) is designated to relay all transactions for a next block processing. A Hub (e.g. one of the nodes) is designated to prepare all of the NCS transactions received from the network nodes plus any received by it from users (e.g. since a last block and as preprocessed by the respective nodes, etc.) to a signed bundle (e.g. a hub content statement (HCS)). The Hub sends the HCS to the Relay. The Relay confirms the HCS and sends the transactions as a signed bundle (e.g. as the RCS) to the nodes of the network.

Each node then performs its own sanity, validity and inclusion checks on the identical set of candidate transactions (in the RCS) prepared from transactions received from nodes of the network that are endorsed by the Hub and the Relay. Each node thus determines a subset of the candidate transactions that it considers to be valid, according to the consensus protocol.

Each node generates a set of administrative transactions that indicate whether Candidate Transactions are Valid (and does other housekeeping), puts these together with the full set of endorsed NVUs (node validation layer unverified transactions bundle), adds some metadata, and commits this as its view of the next VLB (verification layer block). Each Node also puts together all the NAUs (node application layer verified transactions bundle) referenced in the NVUs, adds some metadata, and commits this as its view of the next Application Layer Block (ALB).

Each node follows the protocol's transaction logic (e.g. the hash locked account protocol having rules for secure hash locked accounts) to update the current VLL to a new state based on its own view of the set of valid transactions in the VLB. Each Node also follows the protocol's transaction logic to update the current Application Layer Ledger (ALL) to a new state based on its own view of the set of valid transactions in the ALB (application layer block).

Application Layer Transactions (e.g. Unverified Application Layer User Transactions (UAT)) can pay fees using a coin account, which may be a hash locked coin account, or through a proxy account, (if authorized to do so by the AdminUser in respect of a proxy account). This part of a UAT affects the state of the VLL, while the associated Payload (described further herein) typically updates the ALL.

Table 9 shows an Unverified Application Layer User Transactions:

TABLE 9
Unverified Application Layer User Transactions

| Designator | Meaning | Count |
|---|---|---|
| groupType | =GT_UNVER_APP_USER_TX | SR |
| blockNum | The Target Block Number. | SR |
| chainNum | The Target Chain Number. (More than one chain may | SR |
| | be implemented) | |
| nodeNum | The Target Node ID Number. | SR |
| txType | Transaction Type | SR |
| nonce | The Nonce of Validation Layer Sending Account | SD |
| | (Coin Account for pubKeyUser, or the AdminUser or | |
| | MulitUser Specific Nonce for the Proxy Account with | |
| | IRN = acctNumVal). | |
| amtTx | The Transaction Amount. | SD |
| feeSource | The method of paying transaction fees | SR |
| acctNumVal | The IRN of a Proxy Account that is authorized to pay | SD |
| | Fees for Transactions by listed MultiUsers, and which | |
| | may control Transaction access to an Application | |
| | Layer Record. In the case of a NFT Mint Transaction, | |
| | this will be the Persistent IRN of the NFT Hash | |
| | Locked Record that controls | |
| | and transfers the Application NFT Record. | |
| acctNumApp | The IRN of a Application Layer Record this UAT is | SD |
| | addressing. | |
| refHash | The Hash of Application Layer Transaction Payload | SR |
| | that is paid for with this UAT. Note this is different | |
| | from the Hash of the NFT that this UAT might be | |
| | creating. | |
| pubKeyUser | The Public Key of the User signing below. If | SR |
| | feeSource = COIN_ACCOUNT, then this must also | |
| | hash to the Coin Account Record pays Fees for the | |
| | Transaction. | |
| sigUser | The Signature of the User creating the UAT on the | SR |
| | Data Elements above. | |
| (Payload) | The Type of the Hash referenced Payload Group | SR |
| | varies with the Transaction Type. | |

### NFT Records

NFT Mint Transactions are executed on a Proxy NFT Mint Record and create an Application Layer NFT Record and either a Coin or Hash Locked NFT Account on the Validation Layer to control its ownership. The Application Layer NFT Record contains the Public Key and Signature of the NFT Issuer for Authentication. The Balance held in the Proxy NFT Mint Account Record Must be used to fund initial Balances in the controlling Validation Layer Records, and to pay Transactions Fees. This is the only way to fund the Minting of NFTs.

Minting an NFT actually creates two Records atomically as described herein above: 1) The first is an NFT Application Layer Record itself, which is part of the ALL and is signed by the Issuer. Once this Record is created it cannot be changed or updated in any way. 2) In an embodiment, the second Record is one of a regular Coin account or a Hash Locked Coin Account Record which is part of the VLL. This VLL record controls the ownership and transfer of the corresponding NFT Record in the ALL following similar logic as Coin or Secure Hash Locked Account Records, respectively. It also pays all required Transaction and Ledger Rent Fees for the NFT. If this Hash Locked NFT Record is deleted in some way, the Application Layer NFT Record is also deleted.

Tables 10 and 11 show an NFT Record and NFT Mint Payload.

TABLE 10
NFT Record

| Designator | Meaning | Count |
|---|---|---|
| groupType | =GT_NFT_ACCT_REC | SR |
| nftHash | Hash of NFT. | SR |
| count8 | The number of appLayerMetaData | SR |
| | Data Elements to follow. | |
| MetaDataₙ | Up to a number n (e.g. 5) arbitrary | MO |
| | byte strings (e.g. 64 bytes each). | |
| acctNumApp | The IRN of the NFT Application Layer Record. | SD |
| pubKeyUser | The Public Key of the User signing below. | SR |
| sigUser | The Signature of the User | SR |

TABLE 11
NFT Mint Payload

| Designator | Meaning | Count |
|---|---|---|
| groupType₁ | =GT_NFT_MINT_PAYLOAD | SR |
| nodeNum | The Node Number of the Issuer receiving Fees. | SR |
| issuerFee | Issuer Fee for the Transactions on this Account in | SR |
| | MicroGeeqs | |
| metaData32 | A 32 byte MetaData field to facilitate various use | SR |
| | cases, but with no meaning within protocol. | |
| acctNumReceive | The Hash of the Public Key of PPK pair of the first | SR |
| | owner of the NFT Record if txType = | |
| | MINT_NFT_COIN_TX, or the | |
| | Refund Account if txType = MINT_NFT_HL_TX | |
| hlDigest₁ | Hash Digest One (H₁) | SR |
| hlDigest₂ | Hash Digest Two (H₂) | SR |
| groupType₂ | =GT_NFT_ACCT_REC | SR |
| nftHash | Hash of NFT. (e.g. file, image, description, etc.) | SR |
| count8 | The number (n) of appLayerMetaData Data Elements | SR |
| | to follow. | |
| appLayerMetaData64 | Up to n arbitrary (64) byte strings. | MO |
| acctNumApp | The IRN of the NFT Application Layer Record. | SD |
| pubKeyUser | The Public Key of the User signing below. | SR |
| sigUser | The Signature of the User | SR |

### MINT NFT Transaction Logic (Coin and Hash Locked Accounts)

MINT_NFT_COIN_TX: Upon receipt of the RCS containing a Valid NFT Mint unverified application layer transaction (UAT) and Payload, the Node performs the following: OPERATION: MultiUser Sending_Account_Update_Op(UUT, VLL) and creates in the ALL a Record with the following values:
groupType^{R}=GT_NFT_APP_REC
nftHash^{R}=nftHash^{P}
count8^{R}=count8^{P}
metaData64^{R}=metaData64^{P}
acctNumApp^{R}=acctNumApp^{P}
pubKeyUser^{R}=pubKeyUser^{P}
sigUserR=sigUser^{P}

And creates a VLL record such that
groupType^{R}=GT_COIN_ACCT_REC
blockNum^{R}=Current Block
nonce^{R}=1
recStatus^{R}=COIN_NFT
amtBal^{R}=amtTx^{U}
nodeNum^{R}=nodeNum^{P}
issuerFee^{R}=issuerFee^{P}
blockNumRfd^{R}=Empty
acctNumSend^{R}=Empty
acctNumVal^{R}=acctNumReceive^{P}
metaData32^{R}=metaData32^{P}
acctNumApp^{R}=acctNumApp^{P}.

Regarding the reference to a OPERATION: MultiUser_Sending-__Account_Update_Op(UUT, VLL), in an embodiment, code sharing is involved in that the operations for MultiUser, and Proxy Mint are the same but where in Proxy Mint accounts, there is only an admin user. Thus the same operation is useful.

MINT_NFT_HL_TX: Upon receipt of the RCS containing a Valid NFT Mint unverified application layer transaction (UAT) and Payload, the Node performs the following: OPERATION: Sending_Account_Update_Op(UUT, VLL) and creates an NFT Record with the following values:
groupType^{R}=GT_NFT_APP_REC
nftHash^{R}=nftHash^{P}
count8^{R}=count8^{P}
metaData64^{R}=metaData64^{P}
acctNumApp^{R}=acctNumApp^{P}
pubKeyUser^{R}=pubKeyUser^{P}
sigUserR=sigUser^{P}.
   and creates a second record (coin record) with the following values
groupType^{R}=GT_COIN_ACCT_REC
blockNum^{R}=Current Block
nonce^{R}=1
recStatus^{R}=HL_LOCKED_NFT
amtBal^{R}=amtTx^{U}
nodeNum^{R}=nodeNum^{P}
issuerFee^{R}=issuerFee^{P}
blockNumRfd^{R}=Empty
hlDigest₁^{R}=hlDigest₁^{P}
hlDigest₂^{R}=hlDigest₂^{P}
hlDigest₃^{R}=Empty
acctNumReceive^{R}=Empty
acctNumSend^{R}=acctNumReceive^{P}
metaData32^{R}=metaData32^{P}
acctNumApp^{R}=acctNumApp^{P}.

Note that a Valid NFT Mint Payload will have the Data Elements between groupType2^{R} and pubKeyUser^{R} correctly signed by the Public Key in the Proxy_NFT_Mint Account Record that created the NFT Record.

The following is example process. To initite instantiation of an NFT in the blockchain (e.g. records of the network 108), a User with authority to use an applicable proxy account creates a UAT with the following fields:
groupType^{U}=GT_UNVER_APP_USER_TX
blockNum^{U}=Current Block
chainNumU=Correct Chain
nodeNumU=Node Target Choice (i.e. a particular node of the network to initially receive the transaction for preprocessing and inclusion in an NCS).
txType^{U}=MINT_NFT_COIN_TX or MINT_NFT_HL_TX
nonce^{U}=Proxy Account Nonce
amtTx^{U}≥PARAM_GEEQ_NORM×PARAM_MIN_NFT_AMOUNT
feeSource^{U}=FEE PROXY
acctNumVal^{U}=IRN of the NFT Mint Proxy Account Paying for the NFT and Proxy Record Created.
acctNumApp^{U}=Empty
refHash^{U}=Hash of the NFT Payload
pubKeyUser^{U}=Must correlate to the AdminUser (Issuer) of the NFT Mint Proxy Account above.
sigUser^{U}=Signature of the User Above.

The user then creates an NFT Mint Transaction Payload as outlined above. Hash digests of preimages are provided of a secure hash locked account is attached to the NFT record.

The user sends both to the node of the user's choice and it is processed as outlined above creating both the Controlling NFT Coin or Hash Locked Account and the NFT Application Layer Record.

It is understood that hash locked account record instantiation requires an existing blockchain account and public key, which chain may comprise a GeeqChain in an embodiment. Consuming a bearer token requires a new or existing chain account to receive the proceeds, but does not require a signature.

Unlocking or transferring a secure hash locked account does not require a chain account or public key. The account address given with a transfer transaction need not be real provided the new owner (person in control of the account as holder of the new pre-images) plans to consume or transfer the account before it reverts. This means that it would be possible for an intermediary to create secure bearer account records with coin balances and then transfer them in exchange for fiat or services to an agent without the agent knowing the intermediary's identity even at the level of a chain account number. These tokens (e.g. coin balances) could then be transferred fully anonymously to other agents. In other words, secure bearer tokens function effectively as digital cash and do not require users to maintain private key stores. Similar considerations apply when the secure hash locked account is associated to an NFT record.

Bearer tokens can be created in any amount, but they are non-fungible. They must be transferred or consumed as whole units. Fees are charged for creating, unlocking, transferring, and consuming bearer tokens, and so the value of a bearer token will slowly diminish if it is transferred multiple times.

### Coin Account Records

In addition to the hash locked accounts described, the protocol supports standard coin accounts to hold coins and which are controlled by key pairs, requiring a PPK signature to transact on the account.

A further type of coin account is the NFT coin account as described. This coin account is associated with an NFT record on the application layer but is not hash locked. As described above, this coin account includes four Data Elements not found in Standard Coin Account Records. Two of the data elements are a Node Number and an Issuer Fee. Each time an NFT is Transferred to another User with a Coin NFT Transaction, the Issuer Fee is collected though an Administrative Transaction, and paid to the Issuer that originally Minted the NFT. (Hash locked coin accounts associated with an NFT also have such data elements and also are paid fees in the same manner). The Issuer may choose to set the Fee equal to zero. A further data element comprises a (e.g. 32) Byte MetaData field. The data field is no relevant to the chain protocol and is (external) application dependent. In an example the data field contains a User ID number that allows games and other platforms to associate ownership of NFTs with Users in a Data Base. In an example, the data field contains a registration number that is useful to restrict valid ownership of securities tokenized as NFTs to KYCed individuals, or any other data needed for various NFT Use Cases. For example, in an external data store a listing of permissible owners is maintained, each having a registration number. Transfer may be restricted to permissible owners. A further data element comprises an IRN corresponding to a single NFT Application Layer Record that the NFT Coin Account controls.

A further coin account is a Micro Coin Accounts that is devised for one-time, non-fungible micropayment use. They are similar to Standard Hash Locked Accounts except they are secured by a Private Key which is “burned” by transmitting it to Receiver (instead of a Pre-image). Micro Coins include two data elements not found in Standard Coin Account Records. One such element is a Refund Block Number. When this Block arrives, an automatic Administrative Transaction deletes the Micro Coin Account Record from the VLL and transfers its Balance, less Fees, to the Refund Account. The other element is the Refund Account IRN (acctNumSend^{R}) to which the refund is made if the Refund Block Arrives.

Table 12 shows a Coin Account Record

TABLE 12
Coin Account Record

| Designator | Meaning | Count |
|---|---|---|
| groupType | =GT_COIN_ACCT_REC | SR |
| blockNum | The Last Transaction Block Number. | |
| nonce | The nonce required for the next Valid Transaction. | SR |
| recStatus | Record Type | SR |
| amtBal | The Account Balance of Coins in this Record. | SR |
| nodeNum | The Node Number of the NFT Issuer who may also | SD |
| | receive Fees on NFT Coin Transactions. | |
| issuerFee | Issuer Fee for the Transactions on NFT Coin Account | SD |
| | in MicroGeeqs. This may equal zero. | |
| blockNumRfd | The Coin Account Refund Block Number. | SD |
| acctNumSend | The Account to which the Coins held in the a Micro | SD |
| | Coin Account Record is refunded when the Refund | |
| | Block arrives. | |
| acctNumVal | The IRN of this Validation Layer Record | SR |
| metaData32 | A 32 byte MetaData field to facilitate various use | SD |
| | cases, but having no meaning within protocol. | |
| acctNumApp | IRN of the corresponding NFT Application Layer | SD |
| | Record that this NFT Hash Locked Account controls. | |
| | As above, does not change when the NFT Coin | |
| | Record is transferred. | |

It is understood that Micro Coin Accounts have refund data elements (like hash locked accounts have). NFT coin accounts have NFT related data elements like NFT hash locked accounts have.

Table 13 shows a Coin Transaction:

TABLE 13
Coin Transaction

| Designator | Meaning | Count |
|---|---|---|
| groupType | =GT_UNVER_VAL_USER_TX | SR |
| blockNum | The Target Block Number. | SR |
| chainNum | The Target Chain Number. | SR |
| nodeNum | The Target Node Number. | SR |
| txType | Transaction Type. | SR |
| nonce | The nonce of Validation Layer Sending Account. | SR |
| amtTx | The Transaction Amount. | SD |
| blockNumRfd | The Micro Coin Account Refund Block Number. | SD |
| acctNumReceive | The Receiving Account IRN for the Transaction | SR |
| metaData32 | A 32 byte MetaData field to facilitate various use | SD |
| | cases, but having no meaning within protocol. | |
| pubKeyUser | The Public Key of Sending Account. | SR |
| sigUser | The Signature of the Sending Account that is paying | SR |
| | Fees for this Transaction on the Data Elements above. | |

Coin transaction types include a part transaction, a full transaction, a NFT transaction, and a create transaction. For a part transaction, a specified portion of the coin account balance is transferred out. Fees are levied in addition. Both the Sending and Receiving Accounts are updated by applying the two Update Operations to the appropriate Records in the Ledger. The sending account record remains after such transaction. An existing receiving account is updated or created if one does not exist. The partial transaction applies to standard coin accounts and NFT coin accounts only.

In an example, A User Creates a UVT with txType^{U}=COIN_PART_TX and the following Payload fields:
nonce^{U}=nonce^{R} of the Sending Coin Account with IRN=Hash(pubKeyUser^{U})
amtTx^{U}=Amount to be transferred. Excludes Fees paid by Sending Coin Account
blockNumRfd^{U}=Empty
acctNumReceive^{U}=Receiving Account Address.
metaData32^{U}=Empty
pubKeyUser^{U}=Public Key the Sending Standard Coin Account Record
sigUser^{U}=Signature for the based on the Public Key Above on all above including UVT header

The network verifies the Signature, and makes other Validity Checks, and if the Transaction passes: a. Deducts the amtTxU+amtFee from, and otherwise updates, the Sending Coin Account with Standard_Sending_Account_Update_Op(UUT, VLL). b. Updates or Creates the Receiving Account with Receiving_Account-_Update_Op(UUT, VLL).

In an embodiment, a wallet application is configured to assist with transactions. The Wallet is enabled to keep a store with all Public and Private Keys generated for the user, along with: the current Balance based on Transactions generated; the current Nonce based on the same and the Chain Number where the Account Record lives.

In an embodiment, to assist with destination accounts (payee information) the wallet is enabled to receive destination IRNs from webpages, barcodes, messages, etc. such as provided by a Merchant (e.g. which may be an API).

A full transaction applies to any coin account type to transfer the full balance out, less fees. It is the only transaction type to transfer out of a Micro Coin account. The coin record is deleted by a full transaction.

Upon receipt of the RCS containing a Valid Full Coin Transaction, the Node performs the following: OPERATION: Delete_Sending_Account_Update_Op(UUT, VLL) and OPERATION: Receiving_Account_Update_Op(UUT, VLL).

The process is similar to a part transaction. The amount to transfer is not required as all the balance is removed, less fees. The transaction is signed. The sending account is deleted. The receiving account is updated (or created) with the balance less fees. A full transaction may be used to clean up accounts (e.g. consolidate). If the coin account is a Micro Coin Account, such account are devised to enable a user who set up the account to transfer (communicate) the private key to another party to write the transaction and transfer the full balance less fees to a receiving account of the other party's choosing.

Micro Coins also include an Administrative Refund Block so that if Keys get lost or forgotten, the balance returns to the Micro Coin's Creator. The only security risk would be front-running by the Sender, and the fault could be clearly attributed in this case.

The creation of a NFT coin account is previously described. In a wallet application, according to an embodiment, NFT coin accounts (and NFT Hash Locked Accounts) are presented separately from standard coin accounts or micro coin accounts. Separate user interface presentation and user confirmation is useful to lessen opportunities for a user to consume an NFT related account, removing the NFT record unintentionally.

A coin create transaction is useful to create a micro coin account.

Upon receipt of the RCS containing a Valid Coin Create Transaction, the Node does the following: OPERATION: Standard_Sending_Account_Update_Op(UUT, VLL) and creates Record with:
groupType^{R}=GT_COIN_ACCT_REC
blockNum^{R}=Current Block
nonce^{R}=1
recStatus^{R}=COIN_MICRO
amtTxR=amtTx^{U}
nodeNum^{R}=Empty
issuerFee^{R}=Empty
blockNumRfd^{R}=blockNumRfd^{U}
acctNumSend^{R}=Hash(pubKeyUser^{U})
acctNumVal^{R}=acctNumReceive^{U}
metaData32^{R}=Empty
acctNumAppy=Empty

The following is an example process. A User Creates a UVT with txType^{U}=COIN_CREATE_TX and the following Payload fields:
nonce^{U}=As above
amtTx^{U}=Amount to be transferred to the new Micro Coin Account. Excludes Fees paid by Sending Coin Account.
blockNumRfd^{U}=The Refund Block Number at which the Balance in the Account is returned to Hash(pubKeyUser^{U}), set to Current Block+240,000 by default
acctNumReceive^{U}=As above
pubKeyUser^{U}=As above
sigUser^{U}=As above

The Chain verifies the Signature, and makes other Validity Checks, and if the Transaction passes: a. Deducts the amtTx^{U}+amtFee from the Sending Coin Account with Standard_Sending_Account_Update_Op(UUT, VLL); and b. Creates a new Micro Coin Account as outlined above.

In an embodiment, a wallet application is configured to assist. For example, create key pair, store and manage the key pair, create account number from a random number, etc. The Wallet may limit the amount or suggest low amount to store to the micro coin accounts. It may generate a plurality (e.g. of small like amounts) at one time (e.g. 10 one cent accounts).

In an embodiment, the wallet may communicate and/or store the Private Keys of these small, one time use, Micro Coin Accounts in the High Accessibility Wallet to be used like Bearer Tokens. The high accessibility wallet is configured to communicate preimages and may do so with a website (e.g. to a merchant) in an example. The wallet (whether high accessible or not) may be configured to transfer (communicate) Private Keys of Micro Coins to Merchants (e.g. like Standard Hash Locked Account Pre-images).

In an embodiment, the wallet may set the Refund Block a certain number of Blocks ahead of the current Block, but it may be more convenient for users to be asked how many days or months do they wish before the Micro coins revert. Approximately 30 days is the default, but it might if they are treated like gift cards, many months or a year would be desired.

The payee/micro coin receiver (e.g. a Merchant) is assuming risk with such transactions. The amount is devised to be micro in nature such that the total exposure is intended to be limited. The Merchant can either trust that this Account exists, or he can ask a Node for proof of existence of an Account with IRN equal to Hash(pubKeyUser). If a there does not exist a Micro Coin Account that can be accessed with Public that was delivered, the Merchant's Transaction is invalid, and he gets nothing. Even if the Account exists, the Sending User (or another who may intercept a communication of the private key) could try to send a Full Coin Transaction before the Merchant, recover its Balance, and leave the Merchant with nothing. Since the Sending User is presumed to be the only agent who knows the Private Key and the risk of transfer may be imposed upon the Sending User, responsibility can be assigned. The defense against all of this is that Micro Coin Accounts are meant to contain very small balances for Micropayments and so the Merchant loses very little, and can stop delivering services to the User if a Transaction ever fails to clear.

### Example Video Game Application Using NFTs

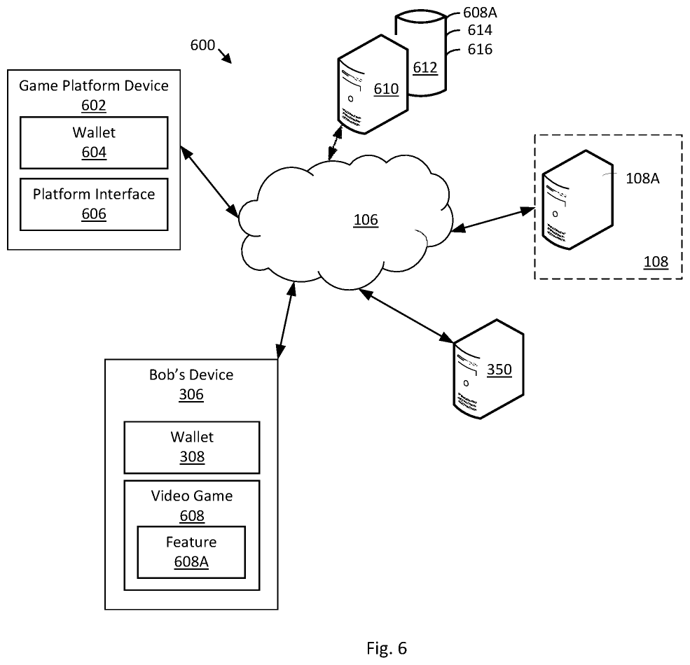

FIG. 6 shows an illustration of network system 600 of a plurality of computing devices, in accordance with an embodiment. Network system 600 is similar to network system 300. Network system comprises an game platform admin device 602, wallet application 604 and platform interface 606. Device 602 is associated with a game platform (e.g. a server) 610 having a datastore (e.g. a data base) 612 for user data (e.g. User IDs), and game features (e.g. 608A) comprising instructions for the game platform, which game features are associated to NFTs on network 108. Platform interface 606 operates with datastore 612. Platform interface 606 permits storing data to the data store 612 and receiving data from store 612, for example, to prepare NFT mint transactions, among other purposes. FIG. 6 is simplified and does not illustrate queries and transactions as does FIG. 3.

Game features are defined as digital assets and associated to respective NFTs maintained by chain network 108. In an embodiment, such game features (e.g. 608A) are used within video game platform 610 (for example within or by game instructions 614). In an embodiment, such game features (e.g. 608A) are configured for user device use (for example within or by game instructions of user video game component 608). As noted, each particular feature is represented by a particular NFT (not shown). Some game features may be unique while others may be a limited plurality (e.g. 1 to N instances of the same feature). A respective NFT is minted on the blockchain maintained by network 108 and associated in an atomic operation at instantiation with a coin account, which may comprise a hash locked coin account as described herein above.

In an embodiment, device 602 is an Issuer and mints the NFTs. Wallet application 604 of device 602 assists with proxy account establishment, NFT minting and other associated transactions for the blockchain and NFTs. For example, in an embodiment, application metadata for the NFT mint transaction (e.g. for the NFT application layer record) is obtained from data store 612. For example, in an embodiment, coin record metadata for the associated coin account on the validation layer record is obtained from data store 612 (for example an admin user ID).

Device 602 mints the NFT and offers the game feature and NFT for sale. The game feature and NFT are offered by platform 610, in an embodiment, within the game (e.g. in accordance with game instructions 614 and 608. In an embodiment, the game feature and NFT are offered via another platform such as an external market for NFTs.

In an embodiment, a game player (e.g. Bob operating via device 306 having a game user ID 616 in datastore 612) may agree to purchase the game feature and NFT. Video game component 608 may be a native application or a browser-based application, as examples. In the illustrated embodiment, the game component 608 is configured to work with an external wallet application 308 (e.g. as a plug-in or via an application program interface (API)) to perform one or more transactions to transfer the NFT to the user for use within the game component 608. In an unillustrated embodiment, the game component comprises a wallet function (e.g. a special purpose wallet).

In an embodiment, a game feature 608A is enabled for use by the game component 608 or platform 610 in response to a state of an NFT record on the blockchain. For example, game platform 610 enables a game user (Bob) to use a game feature 608A in the game in response to a verification of ownership of the NFT by the game user. The game feature 608A is associated to computer instructions or data, which when executed by one or both of Bob's device 306 and platform 610 provide the game feature 608A. The game feature 608A may be enabled for use that is not strictly during game play, for example, to display the feature while not playing. An example game feature comprises a sword, armour, avatar, etc. In an embodiment, the game component 608 (or platform 610) provides a user interface that presents the game feature 608A while playing and while not playing (e.g. when viewing a player profile, a store of NFTs, etc.)

In embodiment, the NFT for game feature 608A is instantiated as a hash locked NFT. In an embodiment, the user agrees to pay with one or more secure hash locked accounts from network 108. The secure hash locked accounts may be associated with an NFT record on the application layer of the blockchain (e.g. an NFT for NFT swap) or may comprise only a coin record on the validation layer (an NFT for Secure Coin swap). Other permissible swaps according to the protocol are possible.

The game provider's NFT and the user's secure hash locked account are transferred using an atomic setup and swap transaction pair as described with reference to FIGS. 3, 4A-4C and 5A-5C.

In an embodiment, the user also receives the associated game feature (e.g. 608A) as instructions for use within the game component 608. The game feature is communicated by platform 610 and enabled for use in response to a state of the blockchain. For example, the game platform 610 reviews the records of the blockchain (e.g. via information service 350) to confirm that the game user (Bob) is the purchaser/owner of the NFT and enables the game feature 608A for the user. In an embodiment, the user may sell or trade the game feature and NFT to another user, as an example. Copying and distributing the game feature alone will not permit use of the feature.

Only the user ID registered in association with the NFT record in the blockchain is enabled to benefit from use of the game feature. In an embodiment, a game platform that mints NFTs for use within its platform is aware of the Application Record Number of the NFT, as well as the NFTs' Hash. In an embodiment, the NFT Hash is associated with (e.g. points to) a database entry maintained by the platform which entry can comprise an image file, a description, a list of attributes, information about artist, issuer, copyright, or licence, pointers to code that implements in-game functionality, etc. Minting the NFT also creates a special Validation Layer Hash Locked or Coin Account that includes the Application Layer Record Number of the associated NFT. The metadata field of the validation layer record is available to store a User ID (e.g. a user's identification/account information in the context of the game platform and such may be encrypted) of the current owner of the Account, and therefore the NFT. By consulting the current state of the Validation Layer Ledger, the platform becomes aware of how the NFTs it has minted are distributed over its Users. As an example, this allows the platform to permit a User who currently owns a magical sword NFT to include it in his inventory and use it in-game as the licence and NFT functions in the database describe. That is, the game platform enables game functions in response to the state of the blockchain with respect to the NFTs associated with the game features.

In an embodiment, a special purpose gaming wallet holds a User's NFTs, or more precisely, the Pre-images (for NFT hash locked accounts) or Private Keys (for NFT coin accounts) that control them. If a User expresses a desire in-game to buy, sell, or trade an NFT, the wallet acts as the agent for the User to execute the transaction. For example, suppose the admin user representing the platform has a magical sword in a chain account, Bob has ten in-game gold coin tokens in respective accounts on the chain, and Bob wishes to acquire the sword. In game communications from Bob would initiate the transactions.

Wallet 604 generates the necessary Atomic Setup data and sends the required elements to Bob's Wallet 308 through the gaming platform. This would include Pre-image/Hash Lock pairs, Admin user User ID (e.g. as metadata for the validation layer record), and a refund block and account number for each of Bob's ten gold coin tokens. Bob's Wallet 308 would do the same in terms of Atomic Setup data. Only one set of data would be generated and exchanged since only one NFT is to be transferred to Bob.

Wallet 604 generates an Atomic Setup Transaction for the sword (i.e. the associated chain account) and sends it to a node on the chain 108 in accordance with a transaction protocol. Bob's wallet 308 would query the chain (e.g. via service of server 350) to confirm that the setup is correct, and if so, composes and sends to the chain a set of ten Atomic Setup Transactions, one for each gold coin. Wallet 604 verifies chain record data, e.g. via server 350, to confirm that the setups are correct, and if so, composes ten Atomic Swap Transactions and sends them to the chain 108. Bob's wallet 308 queries chain data via service of server 350 to verify the existence of the, harvest the Pre-image device 602 used to claim Bob's gold coins, and use this to compose an Atomic Swap Transaction for device 602's Sword. In an embodiment, wallets are configured so that once the respective wallets receive permission to execute the trade, the wallets compose, send, and verify correct setup of the required transactions without further User input. After the swaps are complete, the wallets maintain the Pre-images that control the Hash Locked accounts that, in turn, control ownership of the NFTs that were traded.

In an embodiment, a computing device is configured to perform a method for providing a digital asset by a video game service. The method comprises: invoking atomic instantiation of a digital asset comprising a non-fungible token (NFT) in a blockchain maintained by a transaction network according to a consensus protocol, the digital asset comprising an in-game feature for use by a game user in a video game, the digital asset atomically instantiated by the blockchain in an NFT record in association with a secure hash locked account record, the blockchain preventing a transfer of the NFT record without a transfer of the account record in accordance with a hash locked account protocol, the secure hash locked account record comprising a first hash of a first pre-image and a second hash of a second pre-image to secure the secure hash locked account record under control of the video game service for transferring only upon providing the first pre-image and second pre-image to the blockchain; offering the digital asset to the game user for use in the video game; invoking a transfer of the digital asset on the blockchain by instructing the transfer of the secure hash locked account record to the control of the game user, in accordance with a hash locked account protocol; and enabling use of the digital asset by the game user for use in the game.

In an embodiment, the secure hash locked account record defines a first secure hash locked account record and the transfer of first secure hash locked account record performs an atomic swap of the first secure hash locked account record with a second secure hash locked account record, in accordance with the hash locked account protocol, wherein before the atomic swap the second secure hash locked account record is under control of the game user.

In an embodiment, the method comprises: invoking an unlock transaction to unlock the first secure hash locked account record; and invoking an atomic setup transaction to set up the first secure hash locked account record as unlocked for the atomic swap; wherein the unlock transaction comprises: the first pre-image; and a new hash Ĥ of data comprising a hash of a concatenation of: the second pre-image; a new first hash; and game user data comprising: a blockchain account number received from the game user with which to receive the transfer; metadata of the game user related to video game; and a fourth hash and a fifth hash received from the game user. The fourth hash is determined from a fourth pre-image and the fifth hash is determined from a fifth pre-image for locking the account record when transferred. The new hash replaces the first hash in the first secure hash locked account as unlocked. Further, the atomic setup transaction comprises the second pre-image; the new first hash; and the game user data. The fourth hash replaces the second hash and the fifth hash defines a third hash of the account record as unlocked and set up.

Invoking herein comprises causes to be performed or to occur, or the like. In an example, without limitation, invoking comprises preparing and sending a transaction.

In an embodiment, the method comprises invoking an atomic swap transaction in relation to the first secure hash locked account record as unlocked and as setup.

In an embodiment, invoking the atomic swap transaction is performed upon verification that the second secure hash locked account record is unlocked and set up for atomic swap.

In an embodiment, the method comprises communicating to the game user for use to unlock, setup and swap the second secure hash locked account record: the first hash; the second hash; a third hash of a third pre-image; a blockchain account number of the video game service with which to receive the transfer; and optionally metadata of the video game service related to the game the second secure hash locked account record is associated with a respective NFT.

In an embodiment, the NFT record is static upon instantiation.

In an embodiment, the NFT record comprises arbitrary application data used by the game service to enable use of the digital asset.

In an embodiment, the NFT record is stored in a ledger of an application layer of the blockchain and the secure hash locked account record is stored in a ledger of a validation layer of the blockchain.

In an embodiment, invoking atomic instantiation comprises communicating a transaction request to a first node of a plurality of nodes comprising the transaction network; and wherein, in accordance with the consensus protocol, the first node communicates the transaction for routing to each of the nodes for performing the transaction to maintain respective instances of the blockchain.

In an embodiment, the digital asset comprises instructions for a game feature.

In an embodiment, the method comprises monitoring at state of the blockchain and enabling use of respective digital assets in the video game in response to the monitoring, the respective digital assets associated with respective secure hash locked accounts.

In an embodiment, the respective digital assets are associated to respective game users via the respective secure hash locked account.

### Non-Game NFTs

In an embodiment, the game platform may provide digital assets that are not game features but that are also associated to respective NFTs. An example may be an original digital art work such as from an artist who is associated with the game. For example the artist may have provided artistic works for the game. Separately the artist creates additional original works in the same artistic style of the game, using any game characters, locations, costumes, etc., by way of example. The original work may be sold for use (e.g. display) and associated with an NFT on the blockchain. The NFT is tradeable via the blockchain. The NFTs may be purchase using coin or NFT accounts.

In an embodiment, an entity mints NFTs that represented shares of stock or other securities, voting rights, intellectual or real property, etc. Using NFTs allows ownership and transfer of tokenized objects to be decentralized and under the direct control of Users. Transfer of NFTs are facilitated by a wallet similar to the one described for games. Once whatever input is configured to constitute consent to execute a transaction is received from the User, the wallet communicates with a counterparty and a validating node to complete a trade without additional User intervention.

Communication between users (counterparties) to facilitate such may be performed in any manner (e.g. directly, person to person, face to face, via phone, email, text, bulletin board). Browser-based extensions or applications are configurable to communicate only if their Users direct them to an appropriately provisioned website and give permission. Such a site might be a trading platform that lists inventories of NFTs, or that makes markets in a given type NFT by listing offers to buy and sell, and then making matches that clear the market. Although it is possible to run such a platform in real time with connected users, markets such as these run more smoothly when the commodities are held in custody. Thus, Users might transfer an NFT attached to a coin account (as opposed to a hash locked account) to an account on the trading platform to be held in trust. The trading platform would have private key control of the coin account/NFT and so could directly transfer it between buyers and sellers as needed. Such a platform would also be able to facilitate trades and purchases of NFTs for fiat currencies or other assets not tokenized on a blockchain. Finally, such a platform would be able to restrict its client-base to Users that had passed KYC/AML, or were otherwise complaint with relevant regulatory structures.

Computer device and computer program product aspects are correspondingly associated with any of the method aspects herein and vice versa.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described apparatus or systems. Accordingly, other embodiments are within the scope of the following claims.

Throughout the description and claims of this specification, the word “comprise”, “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers, characteristics, or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

What is claimed is:

1. A method comprising:
receiving a transaction request to record a digital asset comprising a non-fungible token (NFT) to a blockchain, the request received at a node of a plurality of nodes comprising a transaction network, each of the nodes maintaining respective instances of the blockchain in accordance with a consensus protocol;
performing by the node in accordance with a hash locked account protocol of the transaction network:
atomically instantiating an account record associated to a NFT data record in the node's instance of the blockchain, the account record recording a coin account and the NFT data record recording the NFT; and
preventing a transfer of the NFT in the node's instance of the blockchain except in association with a transfer of the coin account; and
wherein the account record comprises a secure hash locked account record associated with the NFT data record, the secure hash locked account record comprising a first hash of a first pre-image and a second hash of a second pre-image to securely lock the transfer of the coin account until the first pre-image and second pre-image are provided to invoke the transfer.

2. The method of claim 1, wherein atomically instantiating comprises defining:
the account record in a ledger of count account records; and
the NFT data record in a ledger of application data records;
such that a completion of the creating of one of the account record and the NFT data record is dependent upon a completion of the creating of the other one of the account record and the NFT data.

3. The method of claim 1 comprising:
in response to an unlock transaction received from a transaction initiator having control of the secure hash locked account record, unlocking the secure hash locked account record for an atomic swap to an intended receiver in exchange for an intended receiver secure hash locked account record, the unlock transaction comprising the first pre-image; and
in response to an atomic setup transaction received from the transaction initiator, setting up the secure hash locked account record as unlocked for the atomic swap, the atomic setup transaction comprising the second pre-image, a new first hash H₁ for locking the secure hash locked account record as setup and intended receiver data for defining the secure hash locked account record for the intended receiver upon completion of the atomic swap.

4. The method of claim 3, wherein:
the unlock transaction supplies the first preimage for verifying the first hash and a new first hash Ĥ to replace the first hash of the secure hash locked account record, wherein hash Ĥ comprises a hash of a concatenation of data comprising:
the second pre-image used to generate the second hash that locks the secure hash locked account record;
the new first hash H₁ for use to lock the secure hash locked account record once setup, wherein H₁=hash (a new preimage P₁); and
the intended receiver data comprising an intended receiver account and a pair of first and second hashes H₄ and H₅ for use to lock the secure hash locked account record once transferred via the atomic swap to the intended receiver, wherein H₄ and H₅ comprise hashes of new pre-images P₄ and P₅ generated by the intended receiver.

5. The method of claim 3, wherein:
the atomic setup transaction supplies the second preimage for verifying the second hash, new first hash H₁ and the intended receiver data; and
the method comprises:
verifying hash Ĥ using the second preimage, new first hash H₁ and the intended receiver data;
storing each of H₁ and the intended receiver data to the secure hash locked account record as set up for the atomic swap.

6. The method of claim 3 comprising, in response to an atomic swap transaction received from the transaction initiator:
verifying H₁; and
responsive to verifying, storing the secure hash locked account record as transferred using the intended recipient data from the secure hash locked account record as setup.

7. The method of claim 3 comprising, in response to respective unlocking, atomic setup and atomic swapping transaction from the intended recipient,
unlocking the intended recipient secure hash locked account record using a received first preimage to verify a first hash of the intended recipient secure hash locked account record;
setting up the intended receiver secure hash locked account record in preparation for the atomic swap using a received second preimage and transaction initiator data as received, the received second preimage used to verify a second hash of the intended recipient secure hash locked account record; and
completing the swap to transfer the intended recipient secure hash locked account record as setup to the transaction initiator using the transaction initiator data stored to the intended recipient secure hash locked account record as setup.

8. The method of claim 1, wherein in accordance with the hash locked account protocol, secure hash locked account records for NFTs comprise:
a field storing application metadata for use by an external application;
a field each for identifying an issuer and an issuer fee to be paid upon any transfer; and
a field each for an account and a refund block, the account to receive a refund should the blockchain reach the a block count of the refund block.

9. The method of claim 1, wherein the secure hash locked account record is enabled for reversion to transfer an account balance to a reversion account number stored in the secure hash locked account record, the transfer automatically performed in response to a count of blocks stored in the blockchain.

10. A method comprising:
invoking a transaction request to record a digital asset comprising a non-fungible token (NFT) to a blockchain, the request communicated to a node of a plurality of nodes comprising a transaction network, each of the nodes maintaining respective instances of the blockchain in accordance with a consensus protocol and processing said transaction in accordance with a hash locked account protocol of the transaction network;
wherein the transaction when performed instantiates an account record associated to a NFT data record in the node's instance of the blockchain, the account record recording a account and the NFT data record recording the NFT;
wherein a transfer of the NFT data record in the node's instance of the blockchain is prevented except in association with a transfer of the account record; and
wherein the account record comprises a secure hash locked account record associated with the NFT data record, the secure hash locked account record comprising a first hash of a first pre-image and a second hash of a second pre-image to securely lock the transfer of the account record until the first pre-image and second pre-image are provided to invoke the transfer.

11. The method of claim 10 comprising invoking an atomic swap in the blockchain of the secure hash locked account record to transfer the NFT, the atomic swap swapping the secure hash locked account record for another secure hash locked account record following an unlocking and setup of the secure hash locked account record using the first hash and second hash and the first preimage and second preimage.

12. The method of claim 11 comprising monitoring blockchain information to determine an unlocking and set up of the other secure hash locked account record before invoking the atomic swap.

13. The method of claim 10 comprising receiving a first replacement hash and a second replacement hash for constructing the atomic swap to replace the first hash and the second hash to lock the secure hash locked account record as swapped.

14. A computing device comprising a processor and a storage device storing instructions which when executed by the processor cause the computing device to perform steps comprising:
receiving a transaction request to record a digital asset comprising a non-fungible token (NFT) to a blockchain, the request received at a node of a plurality of nodes comprising a transaction network, each of the nodes maintaining respective instances of the blockchain in accordance with a consensus protocol;
performing by the node in accordance with a hash locked account protocol of the transaction network:
atomically instantiating an account record associated to a NFT data record in the node's instance of the blockchain, the account record recording a coin account and the NFT data record recording the NFT; and
preventing a transfer of the NFT in the node's instance of the blockchain except in association with a transfer of the coin account; and
wherein the account record comprises a secure hash locked account record associated with the NFT data record, the secure hash locked account record comprising a first hash of a first pre-image and a second hash of a second pre-image to securely lock the transfer of the coin account until the first pre-image and second pre-image are provided to invoke the transfer.

15. The computing device of claim 14, wherein atomically instantiating comprises defining:
the account record in a ledger of count account records; and
the NFT data record in a ledger of application data records;
such that a completion of the creating of one of the account record and the NFT data record is dependent upon a completion of the creating of the other one of the account record and the NFT data.

16. The computing device of claim 14, wherein the instructions which when executed by the processor cause the computing device to perform steps comprising:
in response to an unlock transaction received from a transaction initiator having control of the secure hash locked account record, unlocking the secure hash locked account record for an atomic swap to an intended receiver in exchange for an intended receiver secure hash locked account record, the unlock transaction comprising the first pre-image; and
in response to an atomic setup transaction received from the transaction initiator, setting up the secure hash locked account record as unlocked for the atomic swap, the atomic setup transaction comprising the second pre-image, a new first hash H₁ for locking the secure hash locked account record as setup and intended receiver data for defining the secure hash locked account record for the intended receiver upon completion of the atomic swap.

17. The computing device of claim 16, wherein:
the unlock transaction supplies the first preimage for verifying the first hash and a new first hash Ĥ to replace the first hash of the secure hash locked account record, wherein hash Ĥ comprises a hash of a concatenation of data comprising:
the second pre-image used to generate the second hash that locks the secure hash locked account record;
the new first hash H₁ for use to lock the secure hash locked account record once setup, wherein H₁=hash (a new preimage P₁); and
the intended receiver data comprising an intended receiver account and a pair of first and second hashes H₄ and H₅ for use to lock the secure hash locked account record once transferred via the atomic swap to the intended receiver, wherein H₄ and H₅ comprise hashes of new pre-images P₄ and P₅ generated by the intended receiver.

18. The computing device of claim 16, wherein:
the atomic setup transaction supplies the second preimage for verifying the second hash, new first hash H₁ and the intended receiver data; and
the instructions which when executed by the processor cause the computing device to perform steps comprising:
verifying hash Ĥ using the second preimage, new first hash H₁ and the intended receiver data;
storing each of H₁ and the intended receiver data to the secure hash locked account record as set up for the atomic swap.

19. The computing device of claim 16, wherein the instructions which when executed by the processor cause the computing device to perform steps comprising in response to an atomic swap transaction received from the transaction initiator:
verifying H₁; and
responsive to verifying, storing the secure hash locked account record as transferred using the intended recipient data from the secure hash locked account record as setup.

20. The computing device of claim 16, wherein the instructions which when executed by the processor cause the computing device to perform steps comprising, in response to respective unlocking, atomic setup and atomic swapping transaction from the intended recipient:
unlocking the intended recipient secure hash locked account record using a received first preimage to verify a first hash of the intended recipient secure hash locked account record;
setting up the intended receiver secure hash locked account record in preparation for the atomic swap using a received second preimage and transaction initiator data as received, the received second preimage used to verify a second hash of the intended recipient secure hash locked account record; and
completing the swap to transfer the intended recipient secure hash locked account record as setup to the transaction initiator using the transaction initiator data stored to the intended recipient secure hash locked account record as setup.

21. The computing device of claim 14, wherein in accordance with the hash locked account protocol, secure hash locked account records for NFTs comprise:
a field storing application metadata for use by an external application;
a field each for identifying an issuer and an issuer fee to be paid upon any transfer; and
a field each for an account and a refund block, the account to receive a refund should the blockchain reach the a block count of the refund block.

22. The computing device of claim 14, wherein the secure hash locked account record is enabled for reversion to transfer an account balance to a reversion account number stored in the secure hash locked account record, the transfer automatically performed in response to a count of blocks stored in the blockchain.
